(19) United States
(12) Patent Application Publication
(10) Pub. No.: US 2026/0019961 A1
(43) Pub. Date: Jan. 15, 2026

(54) INDICATION OF GRANULAR INFORMATION FOR UPLINK POWER HEADROOM IN TRIGGER BASED TRANSMISSIONS

(71) Applicant: Cisco Technology, Inc., San Jose, CA (US)

(72) Inventors: Brian D. HART, Sunnyvale, CA (US); Sachin D. WAKUDKAR, St-Sulpice (CH); Nedime Pelin MOHAMED HASSAN SALEM, San Jose, CA (US)

(21) Appl. No.: 19/000,550

(22) Filed: Dec. 23, 2024

Related U.S. Application Data
(60) Provisional application No. 63/670,309, filed on Jul. 12, 2024.
(60) Provisional application No. 63/676,020, filed on Jul. 26, 2024.

(51) Int. Cl. H04W 52/36; H04W 52/02; H04W 52/24

(52) U.S. Cl. CPC H04W 52/367; H04W 52/0235; H04W 52/241

(57) ABSTRACT

The present disclosure provides techniques for reporting of granular information related to a station device's uplink power headroom (UPH) in trigger-based transmissions. A client device identifies one or more power limit reasons that constrain a maximum transmit power of the client device. The client device determines an UPH based on a difference between the maximum transmit power and a current transmit power of the client device. The client device transmits a message to an access point (AP), including the UPH and the one or more power limit reasons. Based on the received information, the AP determines a target RSSI for the client device. The client device receives the target RSSI and an AP transmit power level from the AP, and defines an uplink transmit power as a function of the AP transmit power level and the target RSSI.

### CROSS-REFERENCE TO RELATED APPLICATIONS

This application claims benefit of co-pending U.S. provisional patent application Ser. No. 63/670,309 filed Jul. 12, 2024 and U.S. provisional patent application Ser. No. 63/676,020 filed Jul. 26, 2024. The aforementioned related patent applications are herein incorporated by reference in their entirety.

### TECHNICAL FIELD

Embodiments presented in this disclosure generally relate to wireless communication. More specifically, embodiments disclosed herein relate to the reporting or indication of granular uplink power headroom (UPH) information for improved power management in trigger-based transmissions.

### BACKGROUND

In Wi-Fi Uplink Orthogonal Frequency Division Multiple Access (UL OFDMA) and Multi-User Multiple-Input Multiple-Output (MU-MIMO), the access point (AP) coordinates uplink (UL) transmissions from multiple stations (STAs) using a Trigger Frame (TF). This TF includes various parameters, including transmit power and timing information, which enables synchronized, multi-user uplink transmission. Because multiple STAs transmit trigger-based (TB) physical protocol data units (PPDUs) simultaneously in response to the TF from the AP, power control is needed to manage power effectively and avoid signal degradation or interference.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example uplink trigger-based transmission procedure, according to some embodiments of the present disclosure.

FIG. 2 depicts an example trigger frame format, according to some embodiments of the present disclosure.

FIGS. 3A and 3B depict example UPH control subfield formats, according to some embodiments of the present disclosure.

FIGS. 4A and 4B depict example sequences of messages exchanged between a STA and an AP for granular UPH reporting in trigger-based transmissions, according to some embodiments of the present disclosure.

FIG. 5 depicts an example method for a STA reporting granular UPH information to an associated AP for trigger-based transmissions, according to some embodiments of the present disclosure.

FIG. 6 depicts an example method for a STA reporting granular UPH information to an associated AP for trigger-based transmissions, according to some embodiments of the present disclosure.

FIG. 7 depicts an example method for an AP managing uplink power constraints in trigger-based transmissions, according to some embodiments of the present disclosure.

FIG. 8 depicts an example method for an AP managing uplink power constraints in trigger-based transmissions, according to some embodiments of the present disclosure.

FIG. 9 is a flow diagram depicting an example method for STA UPH reporting, according to some embodiments of the present disclosure.

FIG. 10 is a flow diagram depicting an example method for transmit power management based on reported UPH information, according to some embodiments of the present disclosure.

FIG. 11 depicts an example client device configured to perform various aspects of the present disclosure, according to some aspects of the present disclosure.

FIG. 12 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including identifying, by a client device, one or more power limit reasons that constrain a maximum transmit power of the client device, where the one or more power limits comprise at least one of a network power limit and one or more other power limits, determining, by the client device, an uplink power headroom (UPH) based on a difference between the maximum transmit power and a current transmit power of the client device, transmitting, by the client device, a message to an access point (AP), where the message comprises the UPH and the one or more power limit reasons, where the AP determines a target received signal strength indicator (RSSI) for the client device based on the received UPH and the one or more power limit reasons, receiving, by the client device from the AP, the target RSSI and an AP transmit power level in response to the message, and defining, by the client device, an uplink transmit power as a function of the AP transmit power level and the target RSSI.

One embodiment presented in this disclosure provides a method, including receiving, by an access point (AP) from a client device, a message comprising uplink power headroom (UPH) of the client device and one or more power limit reasons that constrain the UPH of the client device, where the one or more power limit reasons comprises at least one of a network power limit and one or more other power limits, determining, by the AP, a target received signal strength indicator (RSSI) for the client device based on the received UPH and the one or more power limit reasons, sending, by the AP to the client device, the target RSSI and an AP transmit power level in response to the message, and receiving, by the AP, uplink data from the client device, where the uplink data is sent using an uplink transmit power determined as a function of the target RSSI and the AP transmit power level.

Other embodiments in this disclosure provide a system of a network device comprising one or more memories collectively containing one or more programs, one or more computer processors, where the one or more processors are configured to, individually or collectively, perform an operation in accordance with one or more of the above methods.

### Example Embodiments

In trigger-based communication, such as pure UL OFDMA, pure MU-MIMO or UL OFDMA across multiple resource Units (RUs) and MU-MIMO within each RU, the TF serves to coordinate uplink transmissions from multiple non-AP STAs. The TF is used to synchronize and manage these uplink transmissions, allowing the AP to control the timing and parameters of simultaneous transmissions from multiple STAs. Within the TF, transmit power information is provided, such as the AP's transmit power and the target received signal strength indicator (RSSI) of uplink data as it arrives at the AP from the STAs. Each STA uses this information from the TF to adjust and determine its own transmit power when sending uplink data.

However, one challenge within the existing mechanism is that the AP does not have access to the STA's UPH information before sending the TF. The lack of visibility into the STA's remaining transmit power capacity can lead to suboptimal power control, especially when multiple STAs are transmitting at the same time. In Ultra High Reliability (UHR) communication, which has higher requirements for performance and reliability, this issue can lead to increased interference or degraded signal quality.

The present disclosure introduces techniques for client devices (e.g., STAs) to report granular UPH information to their associated APs in trigger-based transmissions. The information reported may include the STA's UPH and/or the factors limiting the UPH, such as the hardware power limit, regulatory power limit, local network power limit, or out-of-band (OBB) spectral emission limit. When the granular information is transmitted in the same PPDU that is subject to the limit(s), without additional signaling, it can be unclear which specific transmit parameters are contributing to the limitation. In some embodiments, the transmit parameters that might affect or contribute to these limits may include the number of spatial streams (NSS), modulation and coding scheme (MCS), and bandwidth configurations. To address this ambiguity, in some embodiments, a specific transmitter parameter that most strongly contributing to these limits may be explicitly identified using related signaling in the UPH Control field or in a new Control field for this purpose. In some embodiments, the report may be sent in a different PPDU than the PPDU that is subject to the limit(s), with the report carried as a management frame (e.g., an action frame) with that PPDU. This management frame in a separate PPDU includes the transmit parameters that are contributing to these limits, such as the number of spatial streams (NSSs), modulation and coding scheme (MCS), and bandwidth configurations (e.g., PPDU bandwidth or resource unit/multi-user resource unit (RU/MRU) width). Based on the detailed information, the AP may dynamically adjust power-related requirements, such as the target RSSI for each STA, to ensure efficient and reliable communication. The AP may also relay these parameters and the constraint to a Radio Resource Manager (RRM), which returns an updated (e.g., higher) local network limit to the AP. In future triggers, the AP may then send the adjusted RSSI to the STA in TF, guiding the STA to use a newly optimized transmit power, still within its maximum allowed limit.

The disclosed UPH reporting mechanism enables the AP and/or the RRM to make more informed decisions regarding uplink power management, particularly in UHR communication environments, leading to improved performance and better power control across the network.

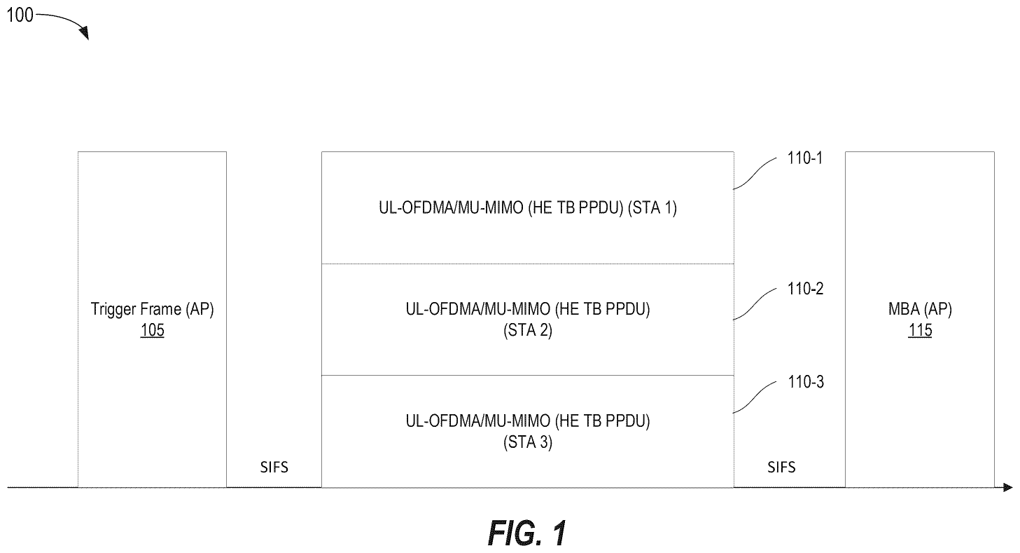

FIG. 1 depicts an example uplink trigger-based transmission procedure 100, according to some embodiments of the present disclosure.

The depicted procedure 100 illustrates the coordination of multiple uplink transmissions in an environment that uses OFDMA and/or MU-MIMO techniques to facilitate resource allocation and simultaneous data transmission from multiple STAs. The procedure begins with the trigger frame (TF) 105, which is sent by an AP to coordinate uplink transmission from multiple STAs (e.g., STA 1, STA 2, and STA 3). The TF 105 contains information to facilitate the synchronized uplink transmission, including timing calculations (when each STA should transmit) and power-related parameters, such as the target RSSI for each STA and the AP's current transmit power, or such as each STA's individually-specified transmission power level.

After the TF 105 is sent, there is a short interframe space (SIFS) between the TF 105 and the uplink transmissions 110. During this time, in some embodiments, the STA may use the AP's transmit power (as indicated in the TF 105) and the measured RSSI to calculate the path loss. The STA may then add the path loss to the target RSSI (as indicated in the TF 105) to determine its own uplink transmit power.

Following the SIFS, STA 1, STA 2, and STA 3 transmit their respective uplink physical protocol data units (UL PPDUs) 110 to the AP, according to the allocated resource units (RUs) and/or streams in the TF 105. Each STA transmits its data simultaneously, but in different RUs and/or streams using the OFDMA and/or MU-MIMO techniques. After receiving the uplink transmissions from all the STAs, the AP sends a multi-STA block acknowledgement (MBA) 115 to acknowledge receipt of the data from the STAs.

In embodiments where the AP sends the TF 105 without knowing the UPH and limiting factors for each STA (e.g., STA 1, STA 2, and STA 3), the target RSSI the AP sets for each STA may only be achievable if the STA exceeds its maximum allowable transmit power. This may lead to situations where the STAs (e.g., STA 1, STA 2, and STA 3) hit their power limits, resulting in inefficient operation or transmission failure due to sending a high Modulation and Coding Scheme (MCS) at less power than needed for reliable reception.

To avoid exceeding power limits, in some embodiments, when the STA (e.g., STA 1, STA 2, and STA 3) receives the initial TF from the AP, it responds by transmitting a first data frame (in a PPDU) that includes its UPH. If the AP detects a problem with the received signal level or a problem in the report in the UPH, the AP then adjusts parameters such as target UL RSSI or AP transmit (Tx) power. The STA subsequently sends another PPDU with the updated UPH, and this cycle continues until the received signal level and/or the reported UPH falls within an acceptable level. This repeated reporting process helps to align the AP's settings with the STA's power constraints, but it has limitations. One drawback is that it creates unnecessary communication overhead (e.g., due to the continuous back-and-forth messaging) and introduces delays in data transmission. Another concern is if the client's constraints come from the TPE elements transmitted by the AP, and are not well addressed by the AP changing the target UL RSSI or AP transmit (Tx) power.

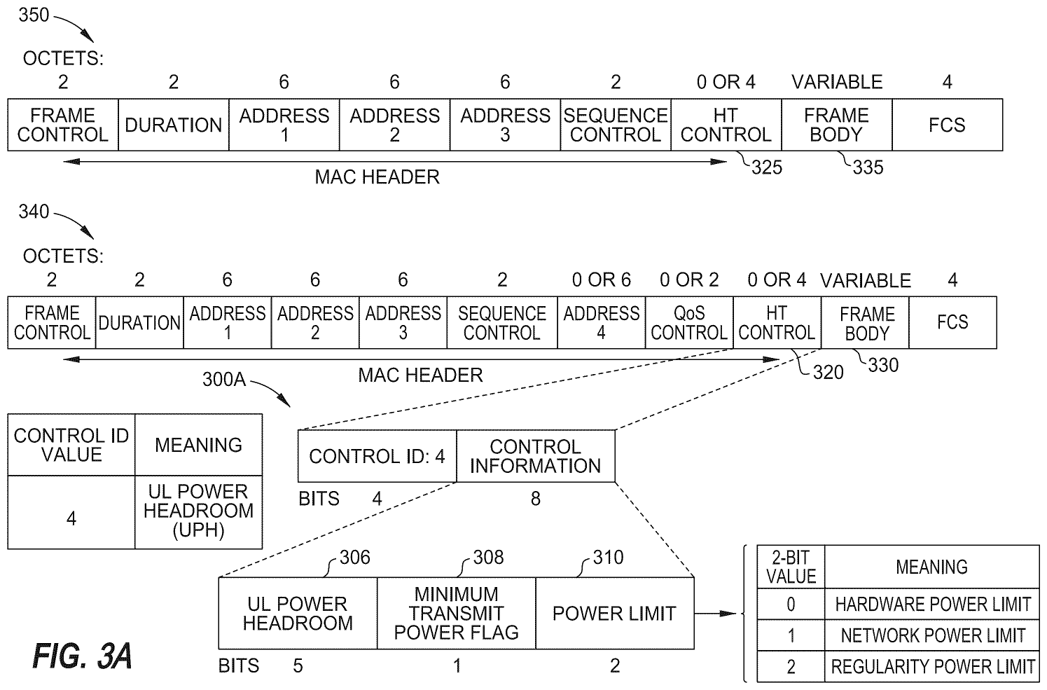

The present disclosure introduces a mechanism for efficient uplink power management, where client devices (e.g., STA 1, STA 2, and STA 3) reports their UPH information (if applicable) and limiting factors to the AP and/or RRM in a streamlined manner. This enables the AP to understand the issue and implement a holistic solution, which may involve increasing the Network TPE constraints, adjusting the target UL RSSI, or modifying the AP transmit (Tx) power. In one embodiment, after receiving the initial TF from the AP, the client device may send a triggered PPDU that includes its UPH information and reason codes indicating the factors limiting the STA's transmit power (e.g., hardware, regulatory, or network limit) to the AP. In embodiments where the UPH is non-zero, the UPH information may be omitted from the report. Through the triggered PPDUs, the AP may progressively learn the STA's power constraints and the underlying conditions. Based on the understanding, the AP may adjust its settings (e.g., TPE elements, AP Tx power and target UL RSSI) accordingly and avoid the need for subsequent repeated UPH reports. In some embodiments, instead of focusing on a single parameter, such as AP Tx power, the AP may holistically address the issue by making changes to a more appropriate parameter set, such as the contents of the TPE elements. In this configuration, the limiting factors (e.g., hardware, regulatory, or network power limits) may be indicated using a 2-bit reason code included within the A-Control subfield in the triggered PPDU (as discussed in more detail below with reference to FIGS. 3A and 3B). The transmit parameters (e.g., NSS, MCS, PPDU BW) are already known to the AP since it sends the triggering MAC frame, and some of these parameters are encoded directly within the structure of the triggered PPDU (e.g., within the triggering MAC frame or the triggered PPDU's PHY headers). This eliminates the need for an explicit report of these settings in some embodiments. In another embodiment, if there is one parameter, more than any other, stands out as the primary cause of the limit, this parameter may be explicitly signaled. This compact parameter may be sent in the UPH Control field or another Control field. When the AP receives the triggered PPDU, the AP understands the limiting factors by analyzing the A-Control subfield and deduces other transmit parameters contributing to the power limit by referencing the PPDU's parameters.

In another embodiment, the AP may first send the STA information about the local network power limits (e.g., transmit power envelope (TPE)) and other relevant constraints. The STA may then evaluate these limits and report the reason codes (e.g., hardware, regulatory, or network limit), as well as conditions (e.g., NSS, MCS, or bandwidth configurations) under which the STA would approach its maximum power capacity (e.g., UPH=0) given its current wireless conditions. Based on the detailed report, the AP, perhaps under control of RRM, adjusts the local network power limits, target UL RSSI and/or AP Tx power preemptively. This approach also prevents repeated UPH reporting and ensures efficient communication. In this configuration, the STA may report the limiting factors and/or transmit parameters using a separate PPDU (that is different from the triggered PPDU) that includes a management frame (e.g., an action frame), with the limiting factors and the transmit parameters reported within the frame body. This decoupled reporting format may be suitable in scenarios where a more extensive report is needed, as it allows the STA to provide the AP with a full transmission profile in a non-real-time manner while reducing the real-time burden when sending the triggered PPDU.

As used herein, the hardware power limit refers to the maximum transmit power the STA can achieve based on the physical capabilities of the STA's hardware components, such as the STA's power amplifier or antenna configuration, while remaining compliant with the requirements established by standardization bodies, specification writing organizations, and/or interoperability testing authorities. The hardware power limit includes in-band hardware power limit and an out-of-band (OOB) hardware spectral emission limit. As used herein, the in-band hardware power limit refers to the maximum power level that the STA can transmit within the assigned channel or frequency band based on the hardware's safe operating capacity (e.g., without risking damages to components or overheating). As used herein, the OOB hardware spectral emission limit refers to the maximum power level permitted to prevent excessive emission outside the assigned frequency band due to hardware limitations. The OOB hardware spectral emission limit prevents interference in adjacent channels or bands. As used herein, the regulatory power limit refers to any constraints imposed by external regulatory authorities, which may set legal maximum transmit power levels for specific frequency bands to prevent interference with other services. The regulatory power limit includes in-band regulatory power limit and an out-of-band (GOB) regulatory spectral emission limit. As used herein, the in-band regulatory power limit defines the maximum allowable transmit power within the assigned frequency band as mandated by regulatory authorities. As used herein, the GOB regulatory spectral emission limit refers to the maximum transmit power permitted by regulatory authorities to prevent excessive emission outside the assigned frequency band. As used herein, the local network power limit refers to limits set by the AP or a network management system (e.g., radio resource management (RRM) system) to manage power across devices within the network. The local network power limit is set to optimize performance and minimize (or at least reduce) interference within the local environment.

With the detailed information received from the STAs (e.g., STA 1, STA 2, and STA 3), the AP and/or RRM may take actions based on the specific limiting factor(s) and/or transmit parameter(s) reported by each STA.

The hardware and regulatory power limits are typically fixed and cannot be increased (e.g., the AP cannot raise the STA's transmit power beyond these limits). In embodiments where the limiting factor reported by STAs includes one or more fixed constraints, the AP may consider actions to lower the power requirements for the STA to keep the transmit power within allowable limits. For example, in some embodiments, the AP may lower the target UL RSSI to reduce the required signal strength to something achievable by the STA for more predictable uplink transmissions. By lowering this threshold, the STA may continue to operate at a transmit power within the capabilities of the fixed hardware and also regulatory limits. In embodiments where interference or channel conditions are poor and/or the regulatory power limit is reported as the constraint, the AP may instruct the STA to move to a different channel with better conditions. A less congested channel may reduce signal degradation and allow the STA to operate at a lower power level while still maintaining a good connection. For OOB spectral emission limits (e.g., due to hardware or regulatory constraints), the AP may reduce the transmission or RU/MRU bandwidth. For example, when the STA reports that a high bandwidth (e.g., large PPDU or RU/MRU width) is causing OOB interference, the AP may reduce the bandwidth to limit emissions outside the assigned frequency band. In embodiments where the report indicates that a high MCS is contributing to the power limit (e.g., the device supports a lowered max power with a higher MCS in order to continue to meet the error-vector magnitude (EVM) requirements for the higher MCS), the AP may reduce the STA's MCS (e.g., switching from 1024-QAM to 256-QAM). A lower MCS requires less signal quality (low EVM), allowing the STA to transmit at higher power.

When the limiting factor reported by STA is the network power limit (also referred to in some embodiments as the local power limit or network-imposed power limit), the AP may communicate with the RRM system to adjust the network power limit that is signaled to STAs via transmit power envelope (TPE) element(s). Since the TPE is managed locally within the network, the RRM may trade-off the benefits of higher system throughput (e.g., lower power operation with more spatial reuse) against the benefits of link level throughput (higher speed between client and AP) especially when the network is lightly loaded, and accordingly increase the TPE, providing the STA with more headroom to operate at higher transmit power levels while still adhering to network performance requirements. If increasing the TPE is not feasible (due to factors such as network performance limitations or interference management constraints), in some embodiments, the AP may consider adjusting the target UL RSSI or other parameters (e.g., MCS, bandwidth) to create an achievable request for the STA and create more predictable UL RSSIs.

The disclosed reporting mechanisms enable the AP to make informed decisions about adjusting power-related requirements and other transmit parameters. The AP may then communicate these adjustments (e.g., adjusted target RSSI) back to each respective STA (e.g., STA 1, STA 2, and STA 3) in the TF 105 to maintain efficient and reliable uplink communication. In another embodiment, if applicable, these adjustments may be sent to the STA via TPE elements included in beacon and/or probe response frames.

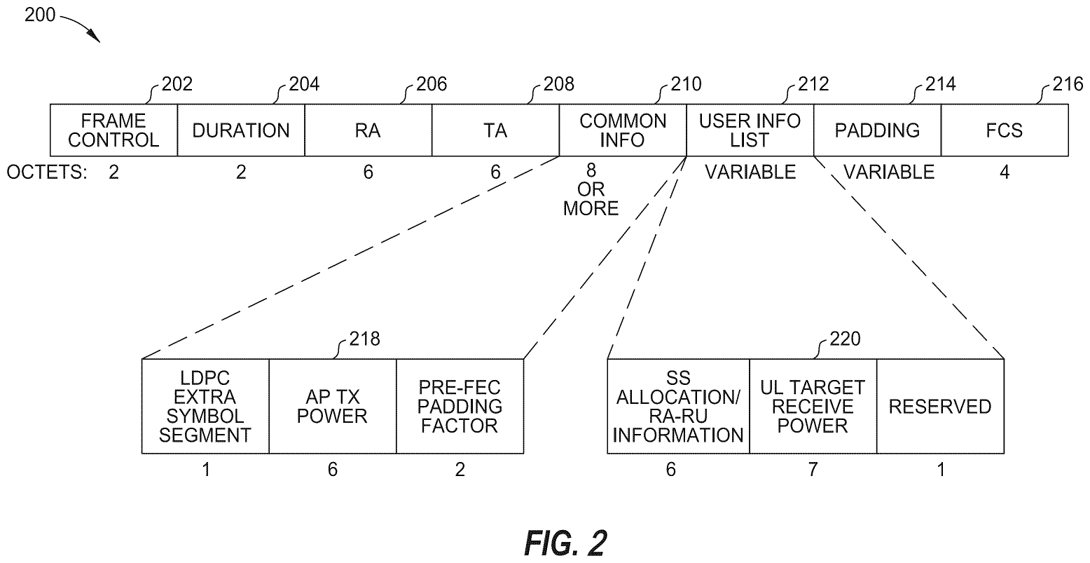

More details about the TF 105 to communicate the adjusted RSSI values and other power-related information to the STAs are disclosed below with reference to FIG. 2. Additionally, more details about the UPH control subfield that the STA uses to report UPH information are disclosed below with reference to FIGS. 3A and 3B.

FIG. 2 depicts an example trigger frame (TF) format 200, according to some embodiments of the present disclosure.

As depicted, the trigger frame includes the following fields: Frame Control field 202, Duration field 204, Receiver Address (RA) field 206, Transmitter Address (TA) field 208, Common Information field 210, User Information List field 212, Padding 214, and Frame Check Sequence (FCS) 216. The Frame Control field 202 includes control information for the TF. The Duration field 204 specifies the duration of the frame exchange process and helps to manage timing for all participating STAs (e.g., STA 1, STA 2, and STA 3 of FIG. 1) and non-participating STAs (e.g., the STAs that do not transmit during the frame exchange). This field prevents undesirable transmissions by other STAs during the ongoing exchange and avoid potential collisions. The RA field 206 includes the address of the device(s) receiving the TF, which is typically multiple STAs and then is the broadcast address. The TA field 208 includes the address of the transmitting device, which is the AP sending the TF. The padding 214 is used to align the frame to the correct byte boundaries, and the FCS includes a checksum for detecting errors in the TF 200.

The Common Info field 210 contains shared information applicable to all STAs participating in the uplink transmission. Within the Common Info field 210, as depicted, an AP Tx Power subfield 218 is included. The AP Tx Power subfield 218 specifies the AP's transmit power used during the transmission. In some embodiments, the STAs may use the AP's transmit power to calculate path loss and adjust their transmit power accordingly.

The User Info List field 212 contains detailed information specific to each STA. As depicted, the User Info List field 212 includes a UL Target Receive Power subfield 220, which includes the target UL RSSI for each STA. The target UL RSSI is the desired signal strength that the AP expects to receive from a client device during uplink communication. It is a value used by the AP to optimize the quality of the uplink transmission by guiding the STA to adjust its transmit power accordingly. The AP monitors the actual received RSSI and, if necessary, communicates adjustments to the STA to match the target RSSI.

The calculation of the required STA transmit power using the AP transmit power and the target UL RSSI, with all input parameters are first referenced to 20 MHz and all output parameters are subsequently referred to the PPDU bandwidth, is provided as follows:

$$Path Loss = AP Transmit Power - DL RSSI measured by STA$$

$$STA Transmit Power = Path Loss + Target UL RSSI$$

This calculation ensures that the STA transmits at a power level that meets the AP's signal quality requirements for reliable communication.

In embodiments where the AP lacks knowledge of the STA's UPH and relevant limiting factors (e.g., hardware, regulatory, OOB, or network-imposed limits), the AP may assign a target UL RSSI that requires the STA to transmit at power levels that exceed its constraints. With the disclosed reporting mechanism, this information may be provided to the AP through two embodiments: (1) by including the UPH and limiting factors directly in the triggered PPDU 110 without an explicit report of transmission parameters, or (2) by having the STA send a separate PPDU containing a management frame containing the limiting factors and transmit parameters (if applicable) before the TF 200 is sent. In either embodiment, the AP may use the received information to adjust the target UL RSSI or other parameters such as AP transmit (Tx) power and/or the TPE element(s) to ensure the STA's transmit power is controlled to meet local and system objectives. In the first embodiment, where UPH and limiting factors are embedded in the triggered PPDU, the AP may communicate these adjustments in beacon and/or probe response frames (such as with updated TPE elements). In the second embodiment, these adjustments may be sent within the TF 200. Upon receiving the TF, each STA may calculate its required uplink transmit power (by adding the path loss to the adjusted target RSSI) and proceed to send its uplink PPDUs (e.g., 110 of FIG. 1) accordingly.

In embodiments where an AP connects to multiple STAs and initiates the trigger-based uplink transmission, the TF 200 needs to be sent to all connected STAs (e.g., STA 1, STA 2, and STA 3). However, different STAs may have different uplink transmission conditions. After receiving the UPH reports from each STA, the AP may determine that some STAs (e.g., STA 1 and STA 2) need a reduced target RSSI to maintain their uplink performance within acceptable limits, while other (e.g., STA 3) may not require any adjustment. In this configuration, the UL Target Receive Power subfield 220 within the TF 200 may specify a different target RSSI for each STA. For example, within the subfield 220, it may indicate a reduced target RSSI for STA 1 and STA 2 to prevent unachievable power usage, while for STA 3, the target RSSI may remain unchanged to maintain stable link performance.

In some embodiments, the TF 200 may further include a subfield that allows the adjustment of transmit parameters, such as the NSS, MCS, PPDU bandwidth, or RU/MRU width, and the like. The subfield may be referred to as Transmit Parameter Adjustment subfield. For example, if the reports from a STA indicate that a high MCS is contributing to the STA's high power usage, causing the UPH to approach or equal zero, the Transmit Parameter Adjustment subfield may include data instructing the STA to reduce the MCS (e.g., switching from 1024-QAM to 256-QAM). In embodiments where multiple STAs are connected and provide UPH reports, the Transmit Parameter Adjustment subfield may include instructions specific to each STA, such as directing STA 1 and STA 2 to reduce their MCS, while STA 3 remain unchanged due to sufficient UPH.

FIG. 3A depicts an example UPH control subfield format 300A, according to some embodiments of the present disclosure. The depicted example UPH control subfield 300A may be part of the A-Control field in the HT Control field (e.g., 320 or 325) within a frame that in turn is part of a PHY Protocol Data Unit (PPDU) (e.g., 340 or 350). Within the HT Control field (e.g., 320 or 325), an A-Control field is included, which contains a list of control subfield, each identified by a control ID with a fixed length.

As depicted, the UPH control subfield 300A include two fields: the Control ID field 302 and the Control Information Field 304. The Control ID field 302 is used to identify the type of information being reported. The value within this field may be predefined by standards. For example, as defined in IEEE 802.11ax, a Control ID value of 4 is used to represent the UPH information, with a fixed length of 8 bits. The Control IDs 7 through 14 are currently reserved (and unassigned). In some embodiments, if new UPH-related information exceeds the existing 8-bit length of Control ID 4, one of the reserved Control IDs (7-14) may be selected to send extended UPH information.

As depicted in FIG. 3A, Control ID 4 for UPH is used within the A-Control field (e.g., inside the HT Control field 320 or 325) to report headroom constraints. The Control Information field 304, with a fixed length of 8 bits, includes three subfields: the UL Power Headroom subfield 306, the Minimum Transmit Power Flag subfield 308, and the Power Limit subfield 310. As illustrated, the UL Power Headroom subfield 306 reports an STA's current UPH (represented using 5 bits), indicating how much power the STA has left before it reaches its maximum transmit power. The UPH may be calculated as follows:

$$UPH = Maximum Transmit Power - Current Transmit Power$$

In some embodiments, the Minimum Transmit Power Flag subfield 308 may be assigned a single bit to indicate whether the STA is operating at or near its minimum transmit power. For example, a value of 0 may represent the STA has not yet transmitted at its minimum power. A value of 1 may represent that the STA is operating at or close to its lowest possible power, suggesting that further reductions in power are not feasible.

The Power Limit subfield 310 may indicate information about the power limits that constrain the STA's maximum transmit power, such as one or more of the hardware power limit, the regulatory power limit, or the network power limit Since the Control Information field 304 has a fixed length of 8 bits, 2-bit value is used in the Power Limit subfield 310 to represent the primary constraint on STA's transmit power. For example, a value of “0” may be defined as representing the hardware power limit, a value of “1” may be defined as representing the network power limit, and a value of “2” may be defined as representing the regulatory power limit. If the hardware power limit is determined as the strictest constraint on the STA's transmit power, the Power Limit subfield 310 may include the value “0” to indicate that the hardware limit is the primary limiting factor. This value informs the AP that the STA's transmit power cannot be increased beyond the hardware limit. In a simpler version of this, when represented as a 2-bit value, the Power Limit subfield 310 may be used differently depending on whether the UPH field 306 is zero or non-zero. If the UPH field 306 is non-zero, this field is reserved or assigned to other purposes. When the UPH field 306 is zero, indicating that the STA has reached its maximum allowable transmit power, specific value may be defined to indicate the power-limiting factor. For example, a non-zero value (typically “1”) may be defined as representing the network power limit, and another value (typically “0”) may be defined as indicating not a network power limit. The remaining values (such as “2” or “3”) may be assigned to indicate additional conditions or combined reasons. For example, a value (like “2”) may signify “reason X which supersedes the reporting of that the network power limit is reached” or “reason X and also the network power limit is reached,” and another value (like “3”) represents “reason X and also the network power limit is not reached.”

Since hardware power limit and regulatory power limit are typically fixed and cannot be adjusted by the AP or the network, in some embodiments, the system may focus on determine whether the local network limit is the constraining factor for the STA's uplink transmission. In this configuration, a 1-bit flag may be used in the Power Limit subfield 310, where a value of “1” indicates that the network limitation is the primary cause of the UPH reaching zero, and “0” indicates that other factors, such as hardware or regulatory power limits, are more restrictive.

The example UPH control subfield format 300A, as depicted in FIG. 3A, is suitable for the first embodiment, where the triggered PPDU (e.g., 100 of FIG. 1) reports UPH information to the AP. The fixed-length Control Information field 304 allows the STA to communicate the UPH value and primary limiting factors using a compact format. In this embodiment, the transmit parameters (e.g., NSS, MCS, bandwidth configurations) are known to the AP and sent by the AP to the client in a Trigger Frame. A reduced set of parameters are encoded within the structure of the triggered PPDU. Therefore, these parameters are known to the AP upon receiving the triggered PPDU, eliminating the need for redundant reporting.

In some embodiments, a 3-dimensional discrete space may be used to represent the limiting factors more granularly. However, since the Control Information field 304 has a fixed length of 8 bits, the 3-dimensional discrete space may be included within a separate control field assigned a new control ID (e.g., 7-14). FIG. 3B illustrates this configuration, where two control fields are used: one with Control ID 4 and another one with Control ID 9 (as an example). The depicted example UPH control subfield format 300B may be part of the HT Control field (e.g., 320 or 325 of FIG. 3A) within a frame that in turn is part of a data unit (PPDU).

As shown in FIG. 3B, the Control Information field 304 for Control ID 4 includes the UL Power Headroom subfield 306, the Minimum Transmit Power Flag subfield 308, and a reserved subfield 312. The Control Information field 324 for Control ID 9 includes the Power Limit subfield 310, where the primary limiting factors are reported using a 3-dimensional discrete space. In the discrete space, each dimension may correspond to a specific limiting factor. For example, when a 3-bit discrete space is used, dimension 0 may be assigned to represent the hardware power limit, where a value of 0 indicates that the hardware is not the limiting factor, while a value of 1 indicates that the hardware is the limiting factor. Dimension 1 may be assigned to represent the network (local) power limit, where a value of 0 indicates that the local network does not impose power restrictions (or that these restrictions are not the limiting factor), while a value of 1 indicates that the network-imposed limit is constraining the STA's transmit power. Dimension 2 may be assigned to represent the regulatory limit, where a value of 0 indicates that the STA's transmit power is not restricted by regulatory standards, while a value of 1 indicates that regulatory power limit is in place or restricting the STA's transmit power. The discrete space allows representation of one or more limiting factors simultaneously. For example, when the hardware is the primary limiting factor, the value within the Power Limit subfield 310 may be represented as 100, indicating that only the hardware limit is constraining the STA's transmit power, while other power limits are not. Typically, only a single power limit is selected as the limiting factor, which is the smallest among the constraints. However, in embodiments where multiple power limits have the same value (e.g., both the hardware and regulatory power limits require that the STA's transmit power does not exceed 20 dBm), multiple power limits may be identified as limiting factors affecting the STA's power headroom. In this configuration, more than one bit may be set to 1. For example, a value of 110 may indicate that both hardware and regulatory limits are constraining the STA's UPH, and the AP needs to consider both constraints when adjusting the target UL RSSI and/or other transmit parameters.

In some embodiments, a 5-dimensional discrete space may be used to represent the limiting factors. For example, dimension 0 may be assigned to represent the in-band hardware limit, dimension 1 for the OOB hardware spectral emission limit, dimension 2 for the in-band regulatory limit, dimension 3 for the OOB regulatory spectral emission limit, and dimension 4 for the network (local) power limit.

In other embodiments, this discrete space may include more or fewer dimensions, allowing the reporting of more or fewer reasons or limiting factors (e.g., certain reasons identified above may be grouped together within a single bit). Additionally, some dimensions in the space may represent other limiting factors not specifically described above.

The control fields describe above, using Control IDs 4 and 9, are suitable for the first embodiment, where the triggered PPDU (e.g., 110 of FIG. 1) reports information including the UPH value and limiting factors (e.g., using 3-bit or 5-bit value) to the AP. In this embodiment, explicit reporting of transmit parameters is not necessary, as these parameters (e.g., NSS, MCS, PPDU BW) are encoded within the structure of the triggered PPDU and can be deduced by the AP upon receiving the PPDU.

For the second embodiment, where decoupled reporting is utilized, a separate PPDU or management frame is sent before TF (e.g., 105 of FIG. 1) to provide the AP with detailed UPH-related information. In this embodiment, the Control Information field 324 may further include an additional Transmit Parameter subfield 314. The Transmit Parameter subfield 314 may be fixed or variable in length and explicitly report one or more transmit parameters that constrain the STA's transmit power. These transmit parameters provide the AP a complete visibility into the STA's configuration. These transmit parameters may include, but are not limited to, the NSS the STA is using for transmission, the MCS the STA is operating under (which determines the modulation order and coding rate), the PPDU bandwidth, the RU/MRU width, the position of the RU/MRU with respect to the PPDU bandwidth, and the path loss between AP and STA (or equivalent parameters such as the AP's transmit power, and the target UL RSSI the AP set for each STA). These parameters contribute to the STA's power constraints and may limit the STA's ability to transmit at higher/lower power levels. In some embodiments, each transmit parameter may be represented with a specific number of bits, with the values indicating the current state of the respective parameter. For example, the NSS may be represented by a 2-bit (or 3-bit) value, where “0” indicates the STA is using 1 stream, “1” indicates 2 streams, and “2” indicates 3 streams, and so on. The MCS may be represented using a 4-bit (or 5-bit) value, where “0” corresponds to MCS 0 (the lowest modulation and coding rate like BPSK rate 1/2), “1” indicates MCS 1, and so forth, depending on the available MCS levels up to the highest supported by the STA. The PPDU BW may be represented by a 2-bit (or 3-bit) value, where “0” represents 20 MHz bandwidth and “1” represents 40 MHz bandwidth. Similarly, RU/MRU width may be represented by a 3-bit (or 4-bit) value, where “0” represents 26 tones, and “1” represents 52 tones, and additional values represent a range of configurations, including 78 tones (52+26), 106 tones, 132 tones (106+26), 242 tones, 484 tones, 996 tones, 1992 tones (2×996), 3984 tones (4×996), as well as punctured variants of these configurations, Specific bits may also be assigned to indicate distributed RUs where applicable. The example bit values are provided for conceptual clarity. Other bits may be assigned to additional parameters, such as the AP transmit power or the target UL RSSI, with their values representing different states or conditions for those respective transmit parameters. A listed field may be split into two or more fields. Two or more listed fields might be combined into a single field.

In some embodiments, an N-dimensional discrete space may be used to represent multiple transmit parameters affecting (or restricting) the STA's transmit power. Each dimension in the N-dimensional space corresponds to a specific transmit parameter. For example, in a 4-dimensional space, dimension 0 is assigned to represent the NSS, dimension 1 represents the MCS, dimension 2 is assigned to the PPDU BW, dimension 3 represents RU/MRU BW. The example of a 4-dimensional space is provided for conceptual clarity. The actual number of dimensions in the space may vary depending on the number of transmit parameters being reported. The N-dimensional space may include more or fewer dimensions, depending on how many parameters are involved in determining the STA's transmit power. Furthermore, each array dimension is discrete. For example, the NSS dimension may support values from 0 to 7, representing NSS=1, 2, 3, 4, 5, 6, 7, and 8 spatial streams, respectively. When a STA reaches its power limits at a particular parameter combination (e.g., a particular point in the N-dimensional space that causes the UPH to be reduced to or near zero), the value at that corresponding point is set to 1, and otherwise, it is set to 0. This forms a large N-dimensional Boolean array, with each 1 indicating a parameter combination that constrains the transmit power. The non-AP STA may send the entire contents of this N-dimensional Boolean array to its AP, such as within a management frame. In another embodiment, the highest parameter value that does not lead to a power limit may be reported in the management frame, for each dimension of the array. Alternatively, the lowest parameter value that does not lead to a power limit may be reported, for each dimension of the array.

Alternatively, when the information is sent in a field of a PPDU and the information is specific to the PPDU, a length-N bitmap may be used to represent multiple transmit parameters affecting (or restricting) the STA's transmit power. Each bit in the length-N bitmap corresponds to a specific transmit parameter. For example, in a length-4 bitmap, bit 0 may be assigned to represent the NSS, bit 1 may represent the MCS, bit 2 may be assigned to the PPDU BW, and bit 3 may represent RU/MRU BW. The example of the length-4 bitmap is provided for conceptual clarity. The actual number of bits in the bitmap may vary depending on the number of transmit parameters being reported. The length-N bitmap may include more or fewer bits, depending on how many parameters are involved in determining the STA's transmit power. When a particular parameter is contributing to the STA reaching its power limits (causing the UPH to be reduced to or near zero), its corresponding bit is set to 1, and otherwise is set to 0. For example, if the STA is set to use a high MCS, achieving this high MCS requires a high transmit power from the STA, bringing the STA close to its power limits (e.g., whether due to hardware, regulatory, network, or OOB constraints). In this configuration, the length-4 bitmap may show “0100,” indicating to the AP that the MCS (bit 1) is the parameter causing the STA's transmit power to approach the limit. If both the MCS (bit 1) and PPDU BW (bit 2) are causing the high transmit power, leaving minimal UPH, the bitmap may show “0110,” suggesting that both parameters are contributing to the issue.

The Control Information field 324, which includes Power Limit subfield 310 and optionally the Transmit Parameter subfield 314, may allow the STA to report to the AP information about the factors or parameters restricting the STA's transmit power (e.g., in a frame such as a data or a management frame which in turn are sent inside a PPDU characterized by the transmit parameters). With the detailed information, the AP and/or RRM can make more informed decisions about managing the uplink transmission. The reporting enables the AP to understand the current limitations the STA is facing and then adjusts the network accordingly, such as by modifying the transmit powers sent in TPE elements, AP Tx power and target UL RSSI sent in the TF, or other transmission settings like MCS or NSS sent in a PPDU or management frame.

In some embodiments, the Transmit Parameter subfield 314 is optional. As discussed above, in the first embodiment, where the AP, by virtue of triggering the PPDU (e.g., 110 of FIG. 1) has sufficient context, explicit reporting of transmit parameters may not be necessary, as these parameters (e.g., NSS, MCS, PPDU BW) may be known to the AP already. In this configuration, the Control Information field 304 may include the UL Power Headroom subfield 306, the Minimum Transmit Power subfield 308, and the Power Limit subfield 310 (as depicted in FIG. 3A), where the Power Limit subfield 310 uses a 2-bit code to represent factors such as hardware, regulatory or network constraints. Alternatively, the Control Information field 304 may only include the UL Power Headroom subfield 306 and the Minimum Transmit Power subfield 308, while a separate Control Information field 324 (with a new Control ID and variable length) contains the Power Limit subfield 310 (as depicted in FIG. 3B), represented by an N-dimensional discrete space or length-N bitmap to reflect more granular constraints.

In the second embodiment, the Transmit Parameter subfield 314 may be included in either a separate PPDU (different from the triggered PPDU 110 as depicted in FIG. 1) containing a management frame (e.g., an action frame). In this configuration, the transmit parameters may be included within the Control Information field 324 or the frame body field of the management frame (e.g., 330 or 335 of FIG. 3A). The decoupled reporting allows the AP to receive detailed UPH information in advance, and adjust network settings in the TF more accurately to accommodate STA-specific limitations.

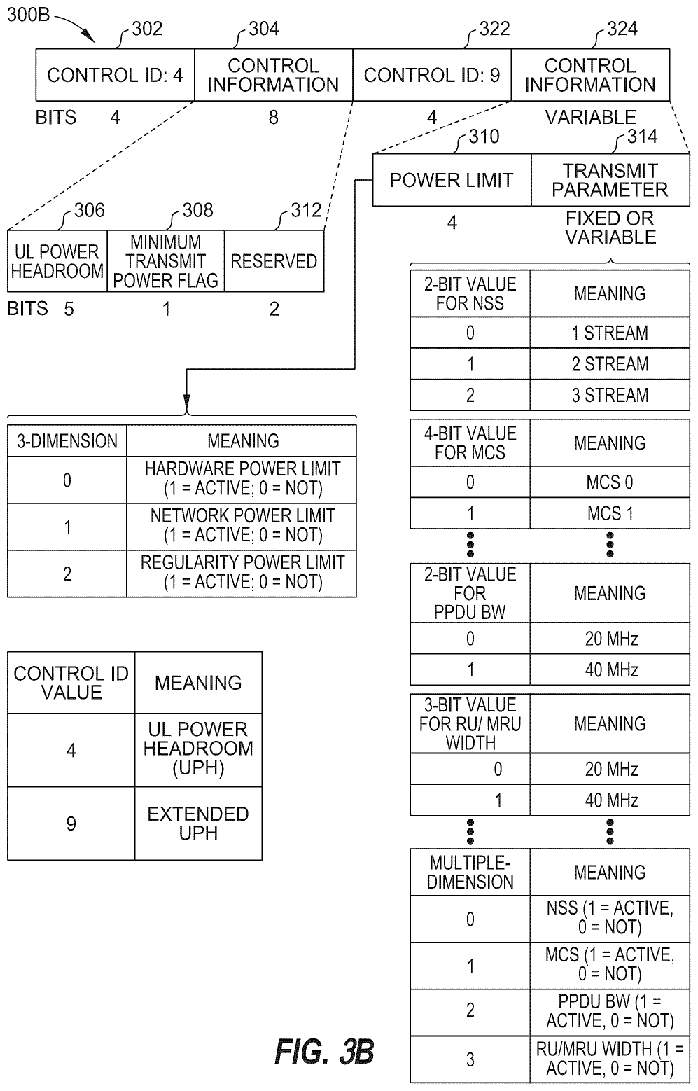

FIG. 4A depicts an example sequence 400A of messages exchanged between a STA and an AP for granular UPH reporting in trigger-based transmissions, according to some embodiments of the present disclosure.

As depicted, within a trigger-based uplink transmission, the AP 405 first sends a TF (e.g., 105 of FIG. 1) to the STA 410 (step 420), which includes parameters such as target UL RSSI and the AP Tx power. The TF serves to initiate and coordinate the uplink transmission from the STA 410.

The STA responds with a triggered PPDU (e.g., 110 of FIG. 1) according to the instructions in the TF (step 425). This triggered PPDU includes information about the STA's UPH value and one or more limiting factors (e.g., hardware, regulatory, or network constraints). These parameters may be embedded within the HT Control field (e.g., 320 of FIG. 3A) of the triggered PPDU (e.g., 340 or 350 of FIG. 3A). In this configuration, since the UPH value and limiting factors are reported within the triggered PPDU, specific transmit parameters (e.g., NSS, MCS, PPDU BW) may not be explicitly reported. In some embodiments, these transmit parameters may be already known to the AP since they are specified in the Trigger Frame used to solicit the triggered PPDU.

The AP 405 reviews the UPH report received from the STA 410. Using the information in the HT Control field, the AP 405 determines if updates are needed to support efficient uplink performance. These updates may include an adjusted UL RSSI or other modifications, such as reducing the MCS, adjusting bandwidth, or assigning a new channel to help the STA 410 transmit within acceptable power limit. If adjustments are required, the AP 405 may share the updates in a subsequent TF with the specific STA 410 (step 430). In some embodiments, the AP 405 may use a control frame or a management frame (e.g., an action frame) to communicate these changes. In some embodiments, the AP may report to the RRM system, where the RRM system evaluates the reported data and determines any further adjustments (e.g., increasing parameters in the TPE element) needed to maintain optimal (or at least improved) performance across the network.

FIG. 4B depicts an example sequence 400B of messages exchanged between a STA and an AP for granular UPH reporting in trigger-based transmissions, according to some embodiments of the present disclosure.

As depicted, before initiating the trigger-based uplink transmission, the AP 405 first shares local network power limits (e.g., TPE elements) and/or other relevant constraints to the STA 410, using a management frame (e.g., a Beacon, Probe Response and/or (Re)Association Response frame) (step 435). Upon receiving this information, the STA 410 evaluates the constraints to identify any limiting factors that might cause its UPH to reach zero. The STA 410 may also analyze one or more transmit parameters (e.g., MCS, NSS, PPDU BW, or channel allocation) that potentially contribute to the power limitation.

Based on the evaluation, the STA 410 sends a decoupled report to the AP, using either a management frame (e.g., an action frame) in a separate PPDU (e.g., different from the triggered PPDU) (step 440). This report optionally includes the UPH value (typically zero), the limiting factor(s) causing the UPH to reach zero, and any contributing transmit parameters. In some embodiments, the limiting factor and UPH data may be embedded within the frame body field of the management frame. In some embodiments, the UPH value may be omitted as the decoupled report is specifically intended to convey the limiting factors and contributing parameters when the UPH is approaching zero.

The AP 405 evaluates the report and makes adjustments to optimize uplink performance. For example, the AP 405 may choose to lower the target RSSI or instruct the uplink transmission to move to a less congested channel. If the AP 405 identifies that the STA is near its transmit power limit due to high MCS settings, it may lower the MCS to reduce the power burden (e.g., switching from 1024-QAM to 256-QAM). When the report indicates that the network power limit is the constraining factor, the AP may take additional steps, such as communicating with the RRM system to consider increasing the TPE. This action may give the STA more headroom, allowing it to operate at a higher transmit power level while staying within the network's limits. Once the evaluation is complete, the AP 405 sends a TF to the STA 410 (step 445), indicating the updated parameters, such as updated target RSSI or newly-defined MCS or bandwidth settings. Upon receiving the TF, the STA 410 sends a triggered PPDU, following the updated parameters included within the TF (step 450).

In some embodiments, in order for the STA 410 to prepare such as detailed reports, several steps need to be performed. In some embodiments, the STA may need to examine all applicable power limits, such as hardware, regulatory, or network limits to determine which imposes the strictest constraint on the STA's maximum transmit power for uplink transmission. Once identified, the STA reports this power limit as the limiting factor to the AP.

In some embodiments, to report which transmit parameter (e.g., NSS, MCS, PPDU BW) are affecting the transmit power and bringing it close to the maximum transmit power (resulting in a UPH near zero), the STA may trigger lower-level awareness and upper-level reporting. More specifically, the lower level of the STA's network stack may be configured to perform real-time monitoring of transmit parameters and report this information to the upper layers. The STA's upper layer may be configured to map the reported parameters to determine if configured (known) limitations are implicated. In some embodiments, the upper level may compress these limitations, and record a simplified set of data for efficient reporting. For example, within a trigger-based transmission, a TX descriptor (which contains transmit-specific details such as NSS, MCS, RU/MRU width, and PPDU BW) may be determined at a lower level, then the key parameters are passed to the upper layer. These parameters, or a range of one or more parameters, serve as indexes into the recorded reasons for the headroom limit present in the upper layer. With this method, the STA's upper layer can determine if a headroom limit has been reached and the specific reason(s) (e.g., NSS, MCS, PPDU BW) for it. The upper level of the STA may then form a response for sending by the lower level and thereby communicate the reasons for the limits and the associated power constraints to the AP (e.g., via a management frame) (step 440), When the local network limit is the primary constraining factor, this information may be encoded with a 1-bit flag, where a value of “1” indicates that the network limitation is the primary cause of the UPH reaching zero.

In some embodiments, the API within the STA's network stack may be used to augment the transmit parameters and facilitate information exchange between the upper layer and lower layer. With the augmented API, the lower layer may report real-time transmit parameters (e.g., NSS, MCS, PPDU BW) to the upper layer. The upper layer may then record, compress, and prepare this data for reporting to the AP.

FIG. 4A depicts the UPH information being communicated within the triggered PPDU, and FIG. 4B depicts the UPH information being communicated within a separate management frame. The depicted examples are provided for conceptual clarity. In some embodiments, the UPH information may be transmitted through other suitable management frames or action frames (e.g., an unsolicited radio measurement report frame), either before or after the association between the STA 410 and AP 405. The UPH control subfields (e.g., 300A of FIGS. 3A and 300B of FIG. 3B) may be flexibly configured to provide the relevant UPH data, depending on specific requirements of the network.

In some embodiments, the power limit (e.g., hardware, regulatory, and network limits) and the transmit parameters (e.g., NSS, MCS, PPDU BW) may be sent separately. For example, the power limit and UPH value may be sent in the probe request or association request or other frames, while the detailed reasons for these limits may be sent later, in an unsolicited radio measurement report frame. This frame may contain a new type of measurement report element that includes relevant details such as problematic NSS, MCS, PPDU BW, RU/MRU width, AP transmit power, and target UL RSSI.

To avoid overwhelming the AP with excessive reports, the reporting may be rate-limited. For example, allowing the client device to send just one frame per second or at a similar interval. This maintains that the reporting is timely without overloading the network with unnecessary messages.

In some embodiments, the transmit parameter (e.g., NSS, MCS, PPDU BW, RU/MRU BW) may be sent using N-bit values, where each value corresponds to a specific configuration. For example, as discussed in FIG. 3B, a 2-bit (or 3-bit) value is allocated to represent NSS, where “0” indicates 1 spatial stream, “1” indicates 2 spatial streams, and so on. This provides a detailed report of the STA's exact configuration. Alternatively, the information may be compressed using an N-dimensional discrete space, where each dimension in the N-dimensional space corresponds to a specific transmit parameter. For example, if a parameter is causing a power limit, its corresponding dimension in the space is set to 1.

In some embodiments, instead of reporting all monitored transmit parameters, the STA 410 may choose to report only the most relevant parameter(s) contributing a power limit. The STA may use an approximate bitmap or a set of parameters indicating the constraints. For example, the STA may involve reporting the highest NSS or MCS that results in the local network power limit restricting the headroom. This approach simplifies the reporting by limiting the number of parameters sent to the AP. It also reduces the complexity and size of the data sent, while still providing valuable information about the constraints.

In some embodiments, the detailed transmit parameter(s) contributing to the limit may be reported when the network power limit is the constraining factor for the STA's maximum transmit power. In other embodiments where the hardware and power limit is the constraining factor, the transmit parameter(s) may be omitted, and the Control field in a data or management frame may only indicate the constraining factor (e.g., represented using a 2-bit or 3-dimensional bitmap). This is because the network limit is the one factor that the AP has direct control over. When the network limit is the constraining factor, reporting these parameters allows the AP to determine which settings are causing the power constraints and take appropriate actions, such as adjusting the target RSSI or communicating with the RRM system to modify the TPE. In some embodiments, the management frame may only include the UPH value and a 1-bit flag (or 2-bit reason code) to indicate whether the network power limit is the constraining factor. If the network limit is the constraint, the flag or reason code is set to 1. Otherwise, the flag or reason code is set to another value such as 0 not indicating this condition. This approach ensures that the STA communicates the relevant information to the AP, allowing the AP to take appropriate actions (e.g., adjusting target UL RSSI for the STA or communicating with the RRM system for power management adjustment), without overloading the network with unnecessary data.

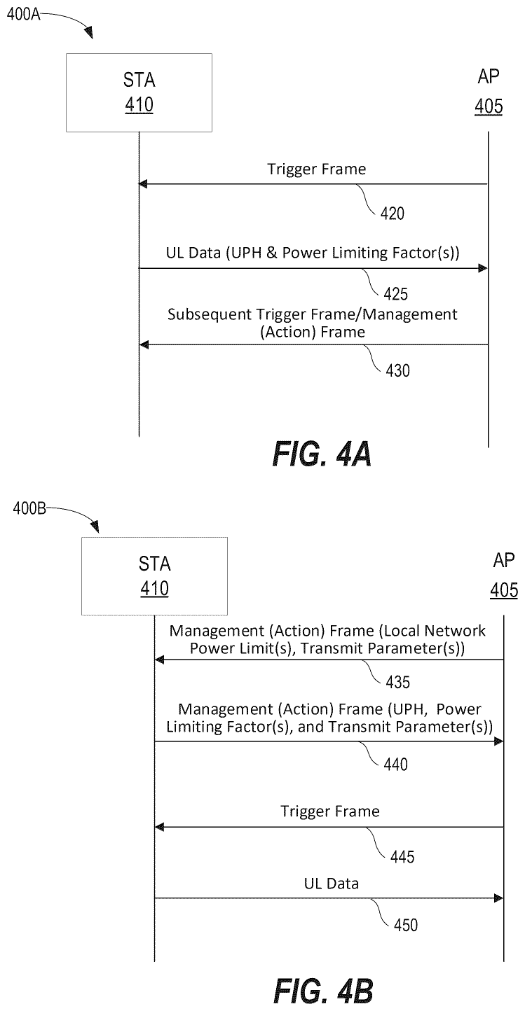

FIG. 5 depicts an example method 500 for a STA reporting granular UPH information to an associated AP for trigger-based transmissions, according to some embodiments of the present disclosure. In some embodiments, the STA may correspond to STA 1, STA 2, or STA 3 as depicted in FIG. 1, or STA 410 as depicted in FIG. 4A.

At block 505, a client device (e.g., 410 of FIG. 4A) receives a TF (e.g., 105 of FIG. 1) sent by its associated AP (e.g., 405 of FIG. 4A). The TF may include the AP's transmit power and a target UL RSSI set for the client device.

At block 510, the client device adjusts its UL transmit settings based on the received instructions. More specifically, the client device first calculates path loss based on the AP's transmit power and the measured RSSI of the AP's signal. The path loss represents the signal degradation that occurs as the AP's signal travels over air and reaches the STA. Using the path loss calculation and the target UL RSSI specified in the TF, the client device determines its UPH and adjusts its transmit power accordingly. Additionally, the client device identifies any limiting factors (e.g., hardware, regulatory or network constraints) impacting its transmit power, rendering that the current UPH.

At block 520, the client devices transmits a triggered UL PPDU (e.g., 110 of FIG. 1) to the AP, following the requirements disclosed in the TF. The PPDU includes the UPH value and relevant limiting factors, which may be embedded within the Control field (e.g., 320 of FIG. 3A).

At block 525, the client devices receives a subsequent TF or management frame (e.g., an action frame) from the AP. The TF or management (action) frame may include updated parameters, such as updated TPE, adjusted target RSSI, or newly-defined MCS. These adjustments allow the client device to align the transmit settings with its power limits to maintain efficient and reliable uplink communication. Following that, the method 500 loops back to block 510, where the STA recalculates its UPH based on the new parameters and makes relevant adjustments to its transmit settings. Since the target RSSI and other parameters have been specifically adjusted by the AP based on a full understanding of the STA's conditions (reported in first TF), the recalculated UPH typically (or more likely) falls within acceptable limits. This reduces the likelihood of repeated reporting, as the AP's customized adjustments help to stabilize the STA's transmit power within the operational range on future uplink transmission.

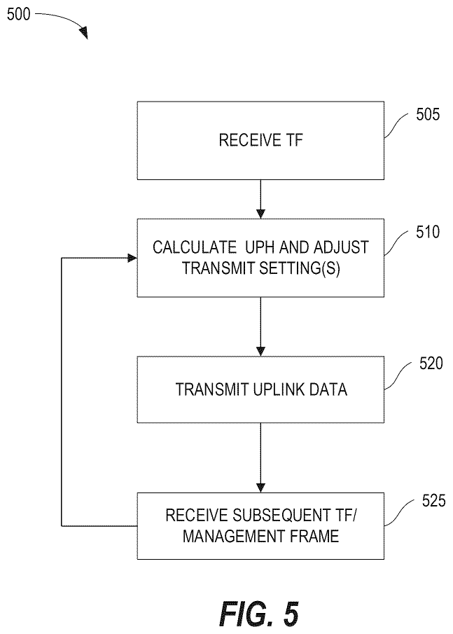

FIG. 6 depicts an example method 600 for a STA reporting granular UPH information to an associated AP for trigger-based transmissions, according to some embodiments of the present disclosure. In some embodiments, the STA may correspond to STA 1, STA 2, or STA 3 as depicted in FIG. 1, or STA 410 as depicted in FIG. 4B.

At block 605, a client device (e.g., 410 of FIG. 4B) receives various applicable power limits from its associated AP (e.g., 405 of FIG. 4B), including the hardware power limit, regulatory power limit, and network power limit. The client device may determine the power limit that imposes the strictest constraint on its maximum transmit power as the limiting/constraining factor. For example, if the STA's hardware limit allows for a maximum transmit power of 20 dBm, which is lower than the power levels allowed by the regulatory limit and local network limit, the hardware power limit is identified as the limiting factor in this configuration. This is because even if the regulatory limit permits a transmit power of 25 dBm or the local network allows up to 23 dBm, the STA is nevertheless constrained by the stricter hardware limit of 20 dBm, as it represents the most restrictive conditions governing the STA's transmit power.

At block 610, the client device uses its current path loss to determine the limiting factors causing its UPH to equal to or close to zero (including values falling within a defined threshold), and identifies any contributing transmit parameters. As used herein, the limiting factor refers to the power limit that imposes the strictest constraint on its maximum transmit power. For example, if the STA's hardware limit allows for a maximum transmit power of 20 dBm, which is lower than the power levels allowed by the regulatory limit and local network limit, the hardware power limit is identified as the limiting factor in this configuration. This is because even if the regulatory limit permits a transmit power of 25 dBm or the local network allows up to 23 dBm, the STA is nevertheless constrained by the stricter hardware limit of 20 dBm, as it represents the most restrictive conditions governing the STA's transmit power. In some embodiments, there may be situation where multiple constraints impose same strict restrictions on the STA's transmit power (e.g., both hardware and regulatory limits allow a maximum transmit power of 23 dBm). In such configuration, both constraints may be treated as limiting factors. The contributing transmit parameters refer to factors or metrics that contribute to the hardware, regulatory, or network power limit, such as MCS, NSS, or PPDU BW. For example, a high MCS or broad PPDU BW may lead to increased power demand, pushing the STA closer to its regulatory or hardware power limits.

At block 615, the client device reports the UPH-related information back to the AP, which may be sent using a management frame (e.g., an action frame) contained within a data frame (PPDU). The UPH value and limiting factors may be included within the Control field (e.g., 320 or 325 of FIG. 3A) of the management or data frame, while the contributing parameters may be included either within the control field (e.g., 320 or 325 of FIG. 3A) (using a new control ID with variable length) or within the frame body field (e.g., 330 or 335 of FIG. 3A) of the frame. In some embodiments, the UPH value may be omitted as the decoupled report focuses on conveying the limiting factors and contributing parameters that lead to the UPH approaching zero.

At block 620, the client device receives a TF (e.g., 105 of FIG. 1 or 200 of FIG. 2) from the AP. The TF may include the AP's transmit power and a target UL RSSI for the STA. In some embodiments, the target UL RSSI and other parameters may be adjusted by the AP (optionally after communicating with the RRM and obtaining feedback) after reviewing the UPR-related data and relevant information (such as when the headroom is shown at or near zero) reported by the client device. The adjustment is to ensure the STA's UL transmit power stays within allowable limits for more predictable behavior. In addition to the power settings, in some embodiments, the TF may also include instructions for the STA to alter transmit parameters, such as lowering the MCS to decrease power requirements, reducing the PPDU or RU/MRU width to avoid out-of-band emissions, or even switching to a less congested channel to improve overall transmission efficiency.

At block 625, the client device calculates the UPH based on the received parameters and adjusts its transmit power accordingly. More specifically, the client device first calculates the path loss by comparing the AP's transmit power with the measured RSSI of the AP's signal. Using the path loss and the target UL RSSI (as indicated in the TF), the client device determines the required transmit power, and based on that, calculates the current UPH. In embodiments where the TF includes instructions that define one or more transmit parameters, such as a lower MCS or reduced bandwidth, the STA may follow the instructions to define transmission settings to align with the updated policy.

At block 630, the client device sends the uplink PPDUs to the AP, using the newly calculated transmit power and any other parameters adjusted per the AP's instructions.

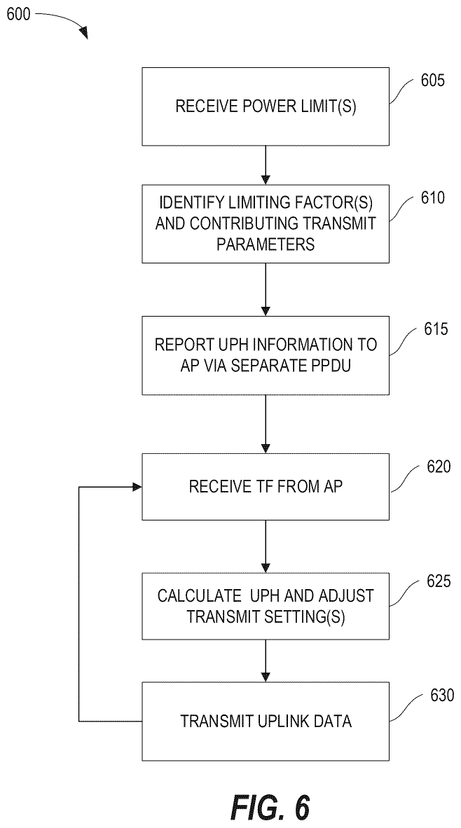

FIG. 7 depicts an example method 700 for an AP managing uplink power constraints in trigger-based transmissions, according to some embodiments of the present disclosure. In some embodiments, the AP may correspond to AP as depicted in FIG. 1 or AP 405 as depicted in FIG. 4A. In some embodiments, the example method 700 may not be limited to an AP, but may be performed by a wireless LAN controller (WLC) or any other network device capable of managing uplink power constraints in trigger-based transmissions.

At block 705, an AP (e.g., 405 of FIG. 4A) initiates trigger-based uplink transmission by sending a TF (e.g., 105 of FIG. 1) to the STA. The TF includes parameters like the target UL RSSI and the AP Tx power, which guides the client device (e.g., 410 of FIG. 4A) in setting up its uplink transmission. In some embodiments, the AP may share power limits to the client device before sending the TF, using a management frame.

At block 710, the AP receives a triggered PPDU sent by the STA in response to the TF. The triggered PPDU includes information about the STA's UPH value and one or more limiting factors (e.g., hardware, regulatory, or network constraints). The AP analyzes the UPH value and the limiting factors to understand the STA's current power conditions.

At block 715, the AP determines whether the reported UPH falls below a defined threshold. The threshold represents an acceptable range where the STA's uplink power headroom is sufficient, and no further adjustments to transmit parameters are required. For example, the AP may set the threshold to ensure that the STA has a small but adequate margin of power headroom for sustained uplink performance under varying conditions. If the UPH is above the threshold, indicating it is within an acceptable range, the method 600 skips blocks 720-740 and moves directly to block 745, where the AP concludes no additional modifications are necessary, and continues to monitor uplink data from the STA. If the UPH falls below the threshold, the method 700 proceeds to block 720.

At block 720, the AP analyzes the reported limiting factor received in the triggered PPDU and infers other relevant transmit parameters that may contribute to the STA's power constraints. By examining these details, at block 725, the AP determines whether the constraint on the STA's maximum transmit power is primarily due to a network-imposed power limit or other factors (e.g., hardware or regulatory limits).

If the constraint is network-imposed, the method 700 moves to block 730. Otherwise, the method 700 skips block 730 and moves directly to block 735. In some embodiments, blocks 730 and 735 may involve no change.

At block 730, the AP reports to the network management system (e.g., RRM system) when the constraint on the STA's power is determined to be due to a network-imposed limit. The RRM evaluates the reported data to decide whether the transmit power the AP and/or its BSS and/or other nearby APs and/or their BSSes can be modified. This includes modifications that may allow the STA to benefit from increased network power, and this determination is indicated to the STA by commanding the AP to send modified TPE element(s) to non-AP STAs in the AP's BSS to provide the STA with more uplink power headroom. As used herein, the TPE is a boundary set for transmitting power that applies to all STAs in the BSS. The RRM system may consider modifying the TPE limit for a BSS when the increase does not violate regulatory or significantly worsen interference conditions, as well as when the increase would improve overall network throughput and/or latency or some other performance metric. This decision considers various network factors, including interference levels, frequency decisions, and overall network performance. In one embodiment, if the reported UPH consistently hits zero due to network power limit and the RRM observes minimal interference within the network, the RRM may raise the TPEs to allow a higher power range. In response, the AP, at block 735, may permit the STA to transmit at a slightly increased power level to meet its uplink needs without compromising network stability. If the reported UPH remains above zero but the RRM detects high interference levels, the RRM may choose to lower the TPEs to mitigate interferences. This adjustments instruct the STA and other devices to operate at a reduced power level, lowering the impact on the network interference and preserving overall performance. In one embodiment, if the UPH reaches zero and the RRM determines that a TPE adjustment is unnecessary (e.g., the interference levels are stable but not warrant reducing TPEs further) the AP, at block 735, may lower the target UL RSSI for the STA, making the STA operates within an achievable power range and maintaining performance predictability without additional network adjustments. In one embodiment, if the reported UPH consistently remains above zero and the RRM also determines no need for TPE adjustments (e.g., stable interference levels), the AP may, at block 735, similarly lower the target UL RSSI for the STA.

In embodiments where the triggered PPDU reveals specific transmit parameters (e.g., high MCS, PPDU BW, RU/MRU width) that contribute to the STA's inability to meet the requested power (e.g., the target UL RSSI), the AP may analyze these parameters to identify which adjustments may help the STA achieve the required power level without compromising signal quality or network performance. For example, reducing the MCS may lead to signal power demands that can be met at acceptable quality, allowing the STA to transmit at the expected power. Similarly, reducing the PPDU BW or RU/MRU width may lower the STA's power load and avoid OOB emission, as a smaller transmission bandwidth requires less power. If the high power load is caused by channel interference or congestion, in some embodiments, the AP may instruct the STA to move to a less congested channel. By switching to a channel with fewer competing signals, the STA may maintain the same level of performance with lower transmit power, reducing its power demands and increasing UPH.

In embodiments where the constraint is not due to network-imposed limits but rather to hardware or regulatory limitations, the AP, at block 735, may adjust relevant power settings based on these fixed constraints, such as lowering the target RSSI or reducing the MCS or bandwidth to manage the STA's transmission power within achievable levels.

At block 740, the AP sends the updated power requirements to the STA, specifying adjustments such as an updated target UL RSSI, revised TPE, or suggestions to change any transmit parameters (e.g., MCS, NSS, or PPDU BW). These updates may be sent using either a management frame (e.g., an action frame) or a subsequent TF, which allows the STA to apply these adjustments in the next round of uplink transmission.

At block 745, the AP continues to monitor the STA's uplink transmission (e.g., 110 of FIG. 1) to evaluate the effectiveness of the adjustments.

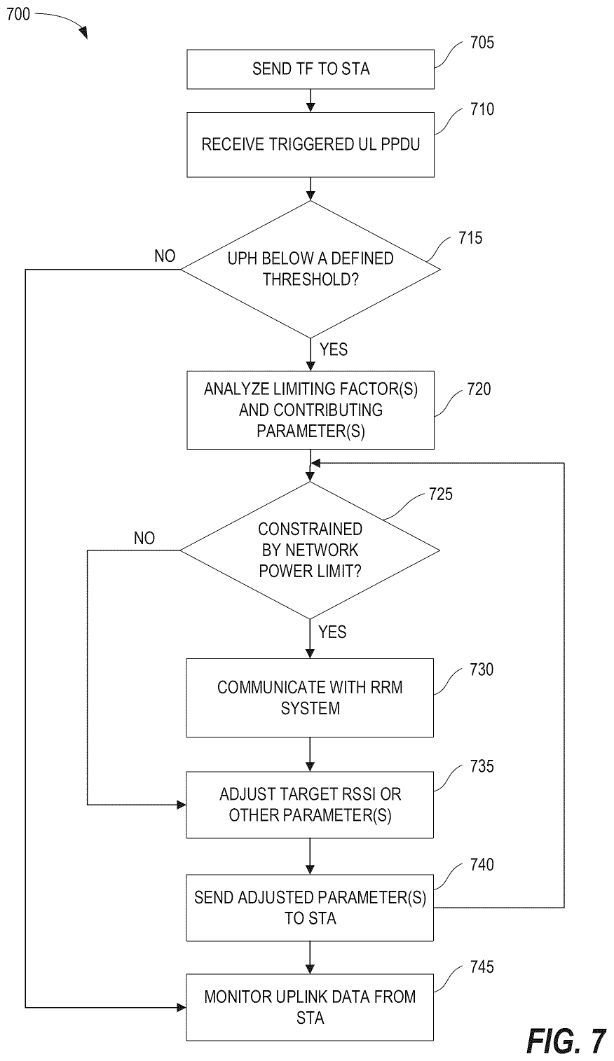

FIG. 8 depicts an example method 800 for an AP managing uplink power constraints in trigger-based transmissions, according to some embodiments of the present disclosure. In some embodiments, the AP may correspond to AP as depicted in FIG. 1 or AP 405 as depicted in FIG. 4B. In some embodiments, the example method 800 may not be limited to an AP, but may be performed by a wireless LAN controller (WLC) or any other network device capable of managing uplink power constraints in trigger-based transmissions.

At block 805, an AP (e.g., 405 of FIG. 4B) sends power limits to a client device (e.g., 410 of FIG. 4B). The STA then uses its current path loss to determine the limiting factors causing its UPH to equal or close to zero (including values falling within a defined threshold), and identifies any contributing transmit parameters. For example, if hardware is identified as the primary constraint, it is designated as the limiting factor in the report. The UPH value (typically 0), limiting factors, and transmit parameters may be included within the control field of the management frame or a separate PPDU. In some embodiments, these parameters may be included within the frame body field of the management frame or PPDU.

At block 810, the AP receives the UPH report from the client device, which include details about the limiting factor causing UPH to equal or close to zero (including values falling within a defined threshold) and one or more transmit parameters contributing to the power constraints.

At block 815, the AP analyzes the limiting factor and transmits parameters provided by the STA to understand the power constraints affecting the client device's uplink transmission.

At block 820, the AP determines whether the STA's maximum transmit power is constrained by a network-imposed power limit. If so, the method 800 moves to block 825. Otherwise, the method 800 skips block 825 and moves directly to block 830. In some embodiments, blocks 825 and 830 may involve no change.

At block 825, the AP communicates with the RRM system to further evaluate the power constraint. The network management system may evaluate, perhaps intermittently, the reported data and assess whether the transmit power for the AP and/or its BSS and/or other nearby APs and/or their BSSes can be modified, including modifications such that it makes sense to allow the STA to have increased network power, and this determination is indicated to the STA by commanding the AP to send modified TPE element(s) to non-AP STAs in the AP's BSS to provide the STA with more uplink power headroom. As used herein, the TPE is a boundary set for transmitting power that applies to all STAs in the BSS. The RRM system may consider modifying the TPE limit for a BSS when the increase does not violate regulatory or significantly worsen interference conditions, as well as when the increase would improve overall network throughput and/or latency or some other performance metric. In the present embodiment, the STA reports the network power limit as the primary constraint causing UPH to equal to or close to zero (including values falling within a defined threshold). In this setup, if the RRM may choose to raise the TPEs when observing minimal interference levels. In response, the AP, at block 830, may permit the STA to transmit at a slightly increased power level to meet its uplink needs without compromising network stability. However, if the RRM observes stable interference levels that are not low enough to justify reducing TPEs further, the RRM may decide not to adjust the TPEs. In response, at block 830, the AP may lower the target UL RSSI for the STA.

At block 830, after receiving any feedback from RRM, the AP may adjust target UL RSSI or other parameters to reduce, increase, or maintain (e.g., leaving unchanged the STA's requested power, allowing the STA to transmit uplink data at a correspondingly lower, higher, or unchanged power level. A lower or unchanged power level may occur when increasing the TPE at block 620 is not feasible or if the STA's maximum transmit power is constrained by hardware or regulatory limits (which are fixed and cannot be increased by the AP). For a lower power level, in some embodiments, the AP may reduce the target UL RSSI it sets for the STA. With this adjustment, the STA may stay within the achievable power limits without maintaining efficient uplink transmission.

In embodiments where the reported data reveals that high MCS, PPDU BW, RU/MRU width, or other transmit parameters are contributing to the STA's inability to meet the requested power (e.g., the target UL RSSI), the AP may adjust these settings. For example, reducing the MCS may lead to signal power demands that can be met at acceptable quality, allowing the STA to transmit at the expected power. Similarly, reducing the PPDU BW or RU/MRU width may lower the STA's power load and avoid OOB emission, as a smaller transmission bandwidth requires less power. If the high power load is caused by channel interference or congestion, in some embodiments, the AP may instruct the STA to move to a less congested channel. By switching to a channel with fewer competing signals, the STA may maintain the same level of performance with lower transmit power, reducing its power demands and increasing UPH.

In embodiments where the constraint is not due to network-imposed limits but rather to hardware or regulatory limitations, the AP, at block 830, may adjust relevant power settings based on these fixed constraints. Since hardware and regulatory power limits are typically outside the AP's control and remain fixed, the AP has limited flexibility. In such configurations, the AP may choose to lower the target RSSI or reduce the MCS or bandwidth to manage the STA's transmission power within achievable levels.

At block 835, the AP sends a TF (e.g., 105 of FIG. 1 or 200 of FIG. 2) to the STA. The TF contains the latest power requirements, such as the updated target UL RSSI or other transmit parameters (e.g., reduced MCS or bandwidth).

At block 840, the AP receives a triggered PPDU from the STA, indicating that the STA has implemented the adjusted power settings in its transmission. At block 845, the AP continues to monitor further uplink transmissions (e.g., 110 of FIG. 1) from the STA, evaluating performance and making any necessary adjustments to support efficient and stable communication.

In embodiments where the AP is connected to multiple STAs, such as STA 1, STA 2, and STA 3, and initiates a trigger-based uplink transmission, each STA may report its UPH to the AP (either via the triggered PPDU or a separate PPDU/management frame). It may occur that the UPHs of STA 1 and STA 2 fall below an acceptable threshold (e.g., zero), requiring adjustments to parameters like the target UL RSSI or other relevant parameters to maintain proper uplink performance. Meanwhile, STA 3 may report sufficient UPH, and no adjustment is needed for uplink transmission. In this configuration, the target RSSI within the TF may be different for each STA (e.g., the target RSSI for STA 1 and STA 2 may need to be reduced, while the target RSSI for STA 3 remain unchanged). To communicate the varied target RSSI, the TF sent to multiple STAs may specify the different transmission parameters for each STA (e.g., within the UL Target Receive Power subfield 220 as depicted in FIG. 2).

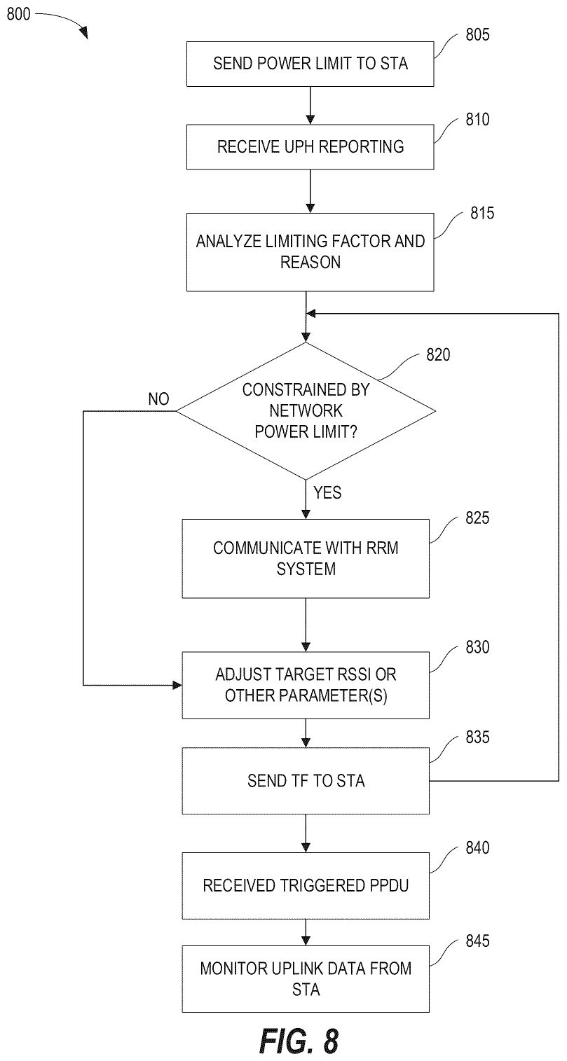

FIG. 9 is a flow diagram depicting an example method 900 for STA UPH reporting, according to some embodiments of the present disclosure.

At block 905, a client device (e.g., STA 410 of FIG. 4) identifies one or more power limit reasons that constrain a maximum transmit power of the client device, where the one or more power limit reasons comprise at least one of a network power limit or one or more other power limits.

At block 910, the client device determines an uplink power headroom (UPH) based on a difference between the maximum transmit power and a current transmit power of the client device.

At block 915, the client device transmits a message to an access point (AP) (e.g., 405 of FIG. 4), where the message comprises the UPH and the one or more power limit reasons, and the AP determines a target received signal strength indicator (RSSI) for the client device based on the received UPH and the one or more power limits.

At block 920, the client device receives, from the AP, the target RSSI and an AP transmit power level in response to the message.

At block 925, the client device defines an uplink transmit power as a function of the AP transmit power level and the target RSSI.

In some embodiments, the message may comprise a management frame, and where the UPH and the one or more power limit reasons may be included within a control field of the management frame.

In some embodiments, the message may further comprise one or more transmit parameters that affect the current transmit power of the client device, the one or more transmit parameters comprising at least one of modulation and coding scheme (MCS), number of spatial streams (NSS), physical protocol data unit bandwidth (PPDU BW), or resource unit (RU) or multi-user resource unit (MRU) width.

In some embodiments, the one or more transmit parameters may be included within a control field (e.g., 325 or 320 of FIG. 3A) of a management frame.

In some embodiments, the one or more transmit parameters may be included within a frame body field (e.g., 330 or 335 of FIG. 3A) of a management frame.

In some embodiments, the network power limit may comprise a limitation imposed by the AP or a radio resource management (RRM) system that controls a maximum transmit power of associated client devices within a basic service set (BSS) of the AP.

In some embodiments, the AP, before determining the target RSSI for the client device, may determine that the UPH of the client device is below a defined threshold and constrained by the one or more power limit reasons, and communicate the UPH and the network power limit to a radio resource management (RRM) system, and the RRM system, considering the one or more power limit reasons on the client device and one or more other client devices in a same network, may perform at least one of allowing an increasing of the maximum transmit power of the client device or modifying a maximum allowed transmit power of the one or more other client devices in basic service sets (BSSs) of the same network.

In some embodiments, the AP, upon determining that the UPH of the client device is below a defined threshold and constrained by at least one of a hardware power limit, the network power limit, or a regulatory power limit, may adjust the target RSSI for the client device to a lower value.

In some embodiments, the client device may further receive, before identifying the one or more power limit reasons, a management frame from the AP comprising at least one of the network power limit, a hardware power limit, or a regulatory power limit.

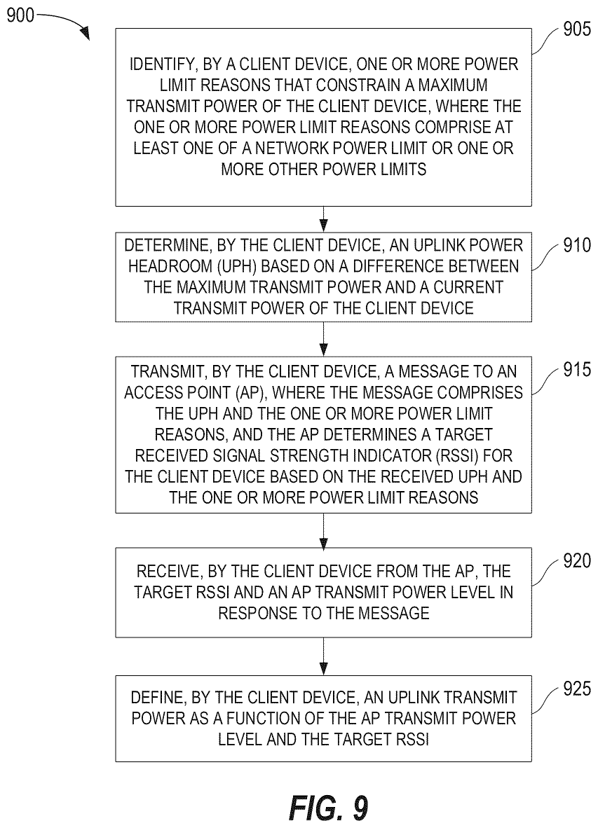

FIG. 10 is a flow diagram depicting an example method 1000 for transmit power management based on reported UPH information, according to some embodiments of the present disclosure.

At block 1005, an AP (e.g., 405 of FIG. 4) receives a message from a client device (e.g., 410 of FIG. 4), a message comprising uplink power headroom (UPH) of the client device and one or more power limit reasons that constrain the UPH of the client device, where the one or more power limit reasons comprises at least one of a network power limit or one or more other power limits (e.g., regulatory power limit or hardware power limit).

At block 1010, the AP determines a target received signal strength indicator (RSSI) for the client device based on the received UPH and the one or more power limit reasons.

At block 1015, the AP sends the target RSSI and an AP transmit power level to the client device in response to the message.

At block 1020, the AP receives uplink data from the client device, where the uplink data is sent using an uplink transmit power determined as a function of the target RSSI and the AP transmit power level.

In some embodiments, the client device may calculate a path loss based on the AP transmit power level and a measured RSSI for the AP, and the client device may determine the uplink transmit power by adding the path loss to the received target RSSI.

In some embodiments, to determine the target RSSI for the client device, the AP may determine that the UPH of the client device is below a defined threshold and constrained by at least one of a hardware power limit, the network power limit, or a regulatory power limit, and in response to the determination, the AP may adjust the target RSSI for the client device to a lower value.

In some embodiments, to determine the target RSSI for the client device, the AP may determine that the UPH of the client device is below a defined threshold and constrained by the network power limit reasons, and in response to the determination, the AP may communicate the UPH and the one or more power limit reasons to a radio resource management (RRM) system, where the RRM system, considering the one or more power limit reasons on the client device and one or more other client devices in a same network, performs at least one of allowing an increasing of the maximum transmit power of the client device or modifying an maximum allowed transmit power of the one or more other client devices in basic service sets (BSSs) of the same network.

In some embodiments, the message may comprise at least one of a management frame, and the UPH and the one or more power limit reasons may be included within a control field (e.g., 320 or 325 of FIG. 3A) of the management frame.

In some embodiments, the message may further comprise s one or more transmit parameters that affect a current transmit power of the client device, the one or more transmit parameters comprising at least one of modulation and coding scheme (MCS), number of spatial streams (NSS), physical protocol data unit bandwidth (PPDU BW), or resource unit (RU) or multi-user resource unit (MRU) width.

In some embodiments, the one or more transmit parameters are included within a control field (e.g., 320 or 325 of FIG. 3A) of a management frame.

In some embodiments, the one or more transmit parameters are included within a frame body field (e.g., 330 or 335 of FIG. 3A) of a management frame.

In some embodiments, the AP may further send a management frame to the client device, comprising at least one of the network power limit, a hardware power limit, or a regulatory power limit.

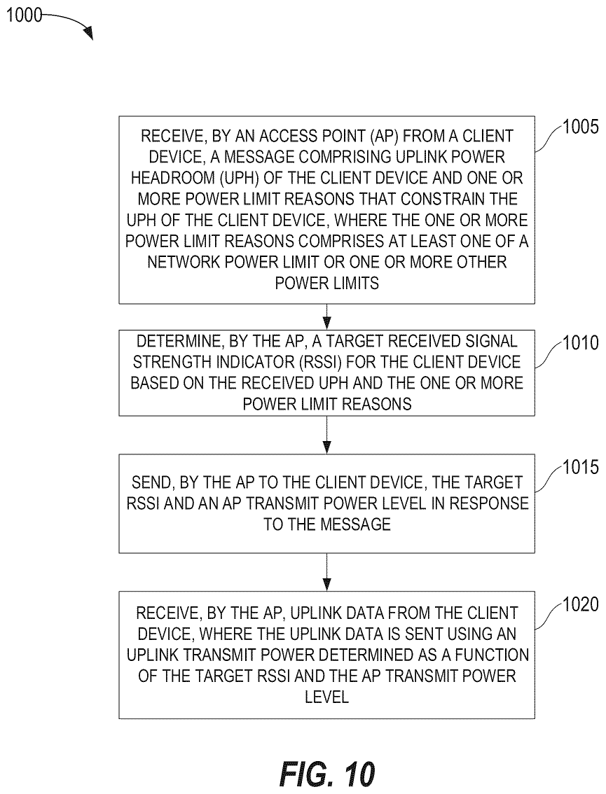

FIG. 11 depicts an example client device 1100 configured to perform various aspects of the present disclosure, according to some aspects of the present disclosure. In some embodiments, the example client device 1100 may correspond to STA 1, STA 2, or STA 3 as depicted in FIG. 1, or STA 410 as depicted in FIGS. 4A and 4B.

As illustrated, the example client device 1100 includes a processor 1105, memory 1110, storage 1115, one or more transceivers 1120, one or more I/O interfaces 1180, and one or more network interfaces 1125. In some embodiments, I/O devices 1140 are connected via the I/O interface(s) 1180. Further, via the network interface 1125, the network device 1100 can be communicatively coupled with one or more other devices and components (e.g., via a network, which may include the Internet, local network(s), and the like). Each of the components is communicatively coupled by one or more buses 1130. In some embodiments, one or more antennas 1135 may be coupled to the transceivers 1120 for transmitting and receiving wireless signals.

The processor 1105 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1105 processes information received through the transceiver 1120, I/O interfaces 1180, and the network interfaces 1125. The processor 1105 retrieves and executes programming instructions stored in memory 1110, as well as stores and retrieves application data residing in storage 1115.

The storage 1115 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1115 may store a variety of data for the efficient functioning of the system.

The memory 1110 may include random access memory (RAM) and read-only memory (ROM). The memory 1110 may store processor-executable software code containing instructions that, when executed by the processor 1105, enable the network device 1100 to perform various functions described herein for wireless communication. In the illustrated example, the memory 1110 includes five software components: the power management component 1145, the transmit parameter management component 1150, the transmit parameter recording component 1155, the API component 1160, and the control & reporting component 1165.

The power management component 1145 is configured to manage the client device's transmit power when performing uplink and/or downlink transmissions. In some embodiments, the power management component 1145 may evaluate various applicable power limits, including the hardware power limit, the regulatory power limit, the local network power limit, and the OOB spectral emission limit. The power management component 1145 may determine which of these constrain is the most restrictive, identify it as the limiting factor, and report this information to the AP. After identifying the limiting factor, in some embodiments, the power management component 1145 may calculate the client device's maximum transmit power based on the identified constraint. Using this information, the power management component 1145 may determine the client device's UPH (which is the difference between the maximum transmit power and the current transmit power) and report the information to the AP. In some embodiments, the power management component 1145 may calculate the client device's uplink transmit power based on the instructions received from an AP. The power management component 1145 may evaluate the parameters included within the TF (e.g., 105 of FIG. 1, 200 of FIG. 2), such as the AP transmit power and the target UL RSSI, and use these inputs to calculate the required uplink transmit power for the client device.

The transmit parameter management component 1150 is configured to track and adjust various transmit parameters that affect the client device's power usage. In some embodiments, the transmit parameter management component 1150 may monitor real-time settings at the lower layer (e.g., Physical Layer) of the client device's network stack, such as NSS, MCS, PPDU BW, or RU/MRU width. These transmit parameters may affect the client device's transmit power and bring it close to the maximum transmit power limits. In addition to tracking, in some embodiments, the transmit parameter management component 1150 may also manage power adjustments based on instructions received from the AP. For example, if the AP suggests lowering the MCS, reducing the bandwidth, or switching channels to conserve power, the transmit parameter management component 1150 may implement these changes and adjust relevant settings to maintain the overall communication efficiency of the client device.

The transmit parameter recording component 1155 is configured to record the power constraints and transmit parameters gathered from the lower layer of the client device's network stack. The transmit parameter recording component 1155 may store the relevant information about which factors or transmit parameters are limiting the client device's performance and which adjustments may help reduce power usage. The recorded data may then be reported to the AP.

The API component 1160 is configured to facilitate communication between the lower layer (where real-time transmit parameters are tracked) and the upper layer (where decisions and reporting are made). The API component 1160 allows the transmit parameter management component 1150 to send monitored values (e.g., NSS, MCS, or bandwidth) to the upper layer of the network stack for analysis and reporting to the AP.

The control & reporting component 1165 is configured to generate the UPH control subfields (e.g., 300A of FIG. 3A or 300B of FIG. 3B) and other management frames that are sent to the AP. The UPH control subfield includes the relevant power information (e.g., UPH values, limiting factors, and transmit parameters) that the AP may use to optimize network conditions.

Although depicted as a discrete component for conceptual clarity, in some embodiments, the operations of the depicted components (and others not illustrated) may be combined or distributed across any number of components. Further, although depicted as software residing in memory 1110, in some aspects, the operations of the depicted components (and others not illustrated) may be implemented using hardware, software, or a combination of hardware and software.

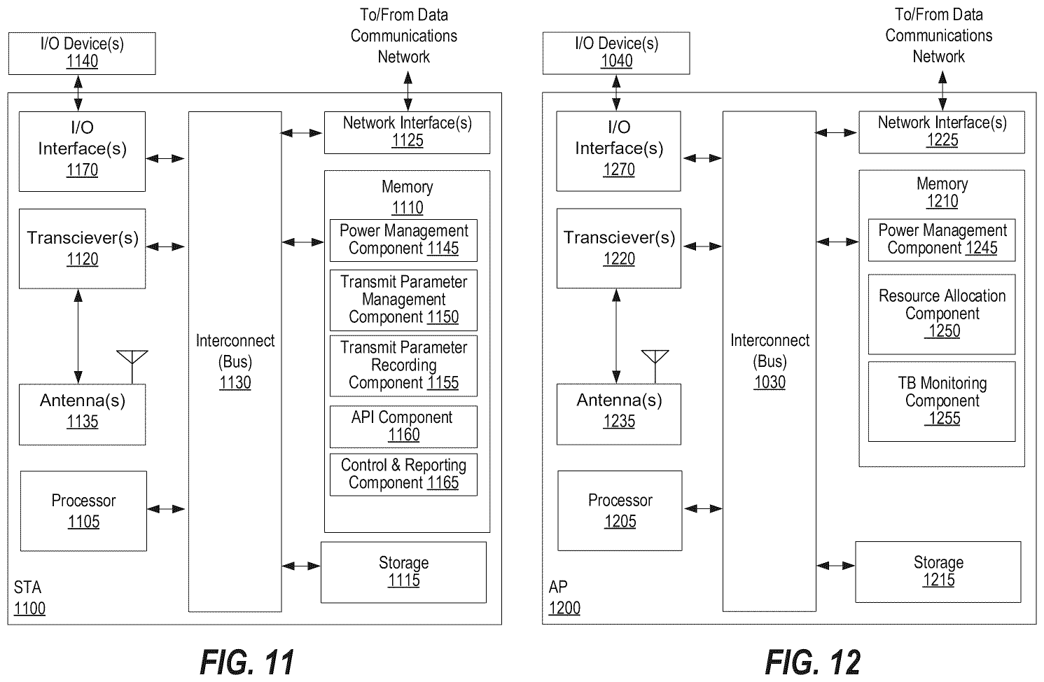

FIG. 12 depicts an example network device 1200 configured to perform various aspects of the present disclosure, according to some aspects of the present disclosure. In some embodiments, the network device 1200 may correspond to an AP, such as the AP as depicted in FIG. 1, or AP 405 as depicted in FIGS. 4A and 4B. In some embodiments, the network device 1200 may correspond to a WLC or any other network device capable of managing uplink power constraints in trigger-based transmissions.

As illustrated, the example network device 1200 includes a processor 1205, memory 1210, storage 1215, one or more transceivers 1220, one or more I/O interfaces 1280, and one or more network interfaces 1225. In some embodiments, I/O devices 1240 are connected via the I/O interface(s) 1280. Further, via the network interface 1225, the network device 1200 can be communicatively coupled with one or more other devices and components (e.g., via a network, which may include the Internet, local network(s), and the like). Each of the components is communicatively coupled by one or more buses 1230. In some embodiments, one or more antennas 1235 may be coupled to the transceivers 1220 for transmitting and receiving wireless signals.

The processor 1205 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1205 processes information received through the transceiver 1220, I/O interfaces 1280, and the network interfaces 1225. The processor 1205 retrieves and executes programming instructions stored in memory 1210, as well as stores and retrieves application data residing in storage 1215.

The storage 1215 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1215 may store a variety of data for the efficient functioning of the system.

The memory 1210 may include random access memory (RAM) and read-only memory (ROM). The memory 1210 may store processor-executable software code containing instructions that, when executed by the processor 1205, enable the network device 1200 to perform various functions described herein for wireless communication. In the illustrated example, the memory 1210 includes three software components: the power management component 1245, the resource allocation component 1250, and the trigger-based (TB) monitoring component 1255.

The power management component 1245 is configured to process the UPH and the limiting factors reported by a client device (e.g., 1100 of FIG. 11). Based on the information, in some embodiments, the power management component 1245 may determine whether the current transmission settings are optimal. Upon determining that the client device is approaching its maximum limits, the power management component 1245 may take appropriate adjustments to UL RSSI or other parameters, such as MCS or bandwidth allocation, to reduce the power load of the client device.

The resource allocation component 1250 is designed to allocate resources like OFDMA subcarriers and MU-MIMO streams based on the power requirements and reports from the client device (e.g., 1100 of FIG. 11).

The TB monitoring component 1255 is configured to manage the trigger-based communication process. In some embodiments, the TB monitoring component 1255 may send TFs (e.g., 105 of FIG. 1, 200 of FIG. 2) to client devices, including the adjusted target UL RSSI and other parameters (e.g., reduced MCS or bandwidth). The TB monitoring component 1255 may also check the received signal strength from the STAs to assess transmission quality and ensure optimal communication performance.

Although depicted as a discrete component for conceptual clarity, in some embodiments, the operations of the depicted components (and others not illustrated) may be combined or distributed across any number of components. Further, although depicted as software residing in memory 1210, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
identifying, by a client device, one or more power limit reasons that constrain a maximum transmit power of the client device, wherein the one or more power limit reasons comprise at least one of a network power limit or one or more other power limits;
determining, by the client device, an uplink power headroom (UPH) based on a difference between the maximum transmit power and a current transmit power of the client device;
transmitting, by the client device, a message to an access point (AP), wherein the message comprises the UPH and the one or more power limit reasons, and the AP determines a target received signal strength indicator (RSSI) for the client device based on the received UPH and the one or more power limit reasons;
receiving, by the client device from the AP, the target RSSI and an AP transmit power level in response to the message; and
defining, by the client device, an uplink transmit power as a function of the AP transmit power level and the target RSSI.

2. The method of claim 1, wherein the message comprises a management frame, and the UPH and the one or more power limit reasons are included within a control field of the management frame.

3. The method of claim 1, wherein the message further comprises one or more transmit parameters that affect the current transmit power of the client device, the one or more transmit parameters comprising at least one of modulation and coding scheme (MCS), number of spatial streams (NSS), physical protocol data unit bandwidth (PPDU BW), or resource unit (RU) or multi-user resource unit (MRU) width.

4. The method of claim 3, wherein the one or more transmit parameters are included within a control field of a management frame.

5. The method of claim 3, wherein the one or more transmit parameters are included within a frame body field of a management frame.

6. The method of claim 1, wherein the network power limit comprises a limitation imposed by the AP or a radio resource management (RRM) system that controls a maximum transmit power of associated client devices within a basic service set (BSS) of the AP.

7. The method of claim 1, wherein the AP, before determining the target RSSI for the client device, determines that the UPH of the client device is below a defined threshold and constrained by the one or more power limit reasons, and communicates the UPH and the network power limit to a radio resource management (RRM) system, and the RRM system, considering the one or more power limit reasons on the client device and one or more other client devices in a same network, performs at least one of allowing an increasing of the maximum transmit power of the client device or modifying a maximum allowed transmit power of the one or more other client devices in basic service sets (BSSs) of the same network.

8. The method of claim 1, wherein the AP, upon determining that the UPH of the client device is below a defined threshold and constrained by at least one of a hardware power limit, the network power limit, or a regulatory power limit, adjusts the target RSSI for the client device to a lower value.

9. The method of claim 1, further comprising receiving, before identifying the one or more power limit reasons, a management frame from the AP comprising at least one of the network power limit, a hardware power limit, or a regulatory power limit.

10. A method, comprising:
receiving, by an access point (AP) from a client device, a message comprising uplink power headroom (UPH) of the client device and one or more power limit reasons that constrain the UPH of the client device, wherein the one or more power limit reasons comprises at least one of a network power limit or one or more other power limits;
determining, by the AP, a target received signal strength indicator (RSSI) for the client device based on the received UPH and the one or more power limit reasons;
sending, by the AP to the client device, the target RSSI and an AP transmit power level in response to the message; and
receiving, by the AP, uplink data from the client device, wherein the uplink data is sent using an uplink transmit power determined as a function of the target RSSI and the AP transmit power level.

11. The method of claim 10, wherein the client device calculates a path loss based on the AP transmit power level and a measured RSSI for the AP, and the client device determines the uplink transmit power by adding the path loss to the target RSSI.

12. The method of claim 10, wherein determining the target RSSI for the client device comprises:
determining, by the AP, that the UPH of the client device is below a defined threshold and constrained by at least one of a hardware power limit, the network power limit, or a regulatory power limit; and
in response to the determination, adjusting the target RSSI for the client device to a lower value.

13. The method of claim 10, wherein, before determining the target RSSI for the client device, the method further comprises:
determining, by the AP, that the UPH of the client device is below a defined threshold and constrained by the one or more power limit reasons; and
in response to the determination, communicating the UPH and the one or more power limit reasons to a radio resource management (RRM) system, wherein the RRM system, considering the one or more power limit reasons on the client device and one or more other client devices in a same network, performs at least one of allowing an increasing of a maximum transmit power of the client device or modifying an maximum allowed transmit power of the one or more other client devices in basic service sets (BSSs) of the same network.

14. The method of claim 10, wherein the message comprises at least one of a management frame, and the UPH and the one or more power limit reasons are included within a control field of the management frame.

15. The method of claim 10, wherein the message further comprises one or more transmit parameters that affect a current transmit power of the client device, the one or more transmit parameters comprising at least one of modulation and coding scheme (MCS), number of spatial streams (NSS), physical protocol data unit bandwidth (PPDU BW), or resource unit (RU) or multi-user resource unit (MRU) width.

16. The method of claim 15, wherein the one or more transmit parameters are included within a control field of a management frame.

17. The method of claim 15, wherein the one or more transmit parameters are included within a frame body field of a management frame.

18. The method of claim 10, further comprising sending, by the AP to the client device, a management frame comprising at least one of the network power limit, a hardware power limit, or a regulatory power limit.

19. A system of a client device in a wireless network, comprising:
one or more memories collectively containing one or more programs;
one or more processors, wherein the one or more processors are configured to, individually or collectively, perform an operation comprising:
identifying, by the client device, one or more power limit reasons that constrain a maximum transmit power of the client device, wherein the one or more power limit reasons comprise at least one of a network power limit or one or more other power limits;
determining, by the client device, an uplink power headroom (UPH) based on a difference between the maximum transmit power and a current transmit power of the client device;
transmitting, by the client device, a message to an access point (AP), wherein the message comprises the UPH and the one or more power limit reasons, and the AP determines a target received signal strength indicator (RSSI) for the client device based on the received UPH and the one or more power limit reasons;
receiving, by the client device from the AP, the target RSSI and an AP transmit power level in response to the message; and
defining, by the client device, an uplink transmit power as a function of the AP transmit power level and the target RSSI.

20. The system of claim 19, wherein the message further comprises one or more transmit parameters that affect the current transmit power of the client device, the one or more transmit parameters comprising at least one of modulation and coding scheme (MCS), number of spatial streams (NSS), physical protocol data unit bandwidth (PPDU BW), or resource unit (RU) or multi-user resource unit (MRU) width.
